(19) United States
(12) Patent Application Publication
(10) Pub. No.: US 2025/0211398 A1
(43) Pub. Date: Jun. 26, 2025

(54) METHODS, SYSTEM, AND APPARATUS FOR COMMUNICATING LOW PEAK-TO-AVERAGE POWER RATIO (PAPR) MULTIPLEXED SIGNALS

(71) Applicant: Huawei Technologies Co., Ltd., Shenzhen (CN)

(72) Inventors: Ming Jia, Ottawa (CA); Jianglei Ma, Ottawa (CA)

(21) Appl. No.: 19/076,793

(22) Filed: Mar. 11, 2025

Related U.S. Application Data
(63) Continuation of application No. PCT/CN2022/118664, filed on Sep. 14, 2022.

(51) Int. Cl. H04L 5/00; H04L 27/20

(52) U.S. Cl. CPC H04L 5/0053; H04L 27/206

(57) ABSTRACT

The present disclosure relates to communicating low peak to average power ratio (PAPR) multiplexed signals. Signaling related to sub-sequences of a base sequence is communicated in a wireless communication network, and a multiplexed signal is transmitted and received between a first communication device and a second communication device. The multiplexed signal that multiplexes a number of signals that are based on respective ones of the sub-sequences. The sub-sequences each comprise a unique subset of non-consecutive values from the base sequence, and those values are equally spaced apart by one or more zero values and are at different positions within each of the sub-sequences. The signals comprise components that are equally spaced apart and at different positions within each of the signals such that consecutive components of the multiplexed signal comprise the components of different ones of the signals.

### CROSS-REFERENCE TO RELATED APPLICATION

This application is a continuation of International Application No. PCT/CN2022/118664, filed on Sep. 14, 2022, the disclosure of which is hereby incorporated by reference in its entirety.

### TECHNICAL FIELD

The present application relates generally to wireless communications, and more specifically to communicating, by transmitting and/or receiving, low peak to average power ratio (PAPR) multiplexed signals.

### BACKGROUND

In some wireless communication systems, a low PAPR waveform is preferred for at least certain types of signals such as a demodulation reference signal (DMRS). For this reason, Zadoff-Chu (ZC) sequences are often used in DMRS generation. In 5th generation (5G) new radio (NR), for example, a π/2-binary phase shift keying (BPSK) waveform is used for uplink multi-user multiple input multiple output (MU-MIMO), and a comb-based (in frequency domain) π/2-BPSK waveform is used for different user DMRSs.

The process for generating a DMRS for each user involves selecting a sequence for the DMRS, and each user uses a π/2-BPSK modulated sequence, so that its individual time domain signal has low PAPR. The DMRS signals will add up in the air, but can be separated in the frequency domain at a receiver.

This DMRS design is intended for different users in MU-MIMO systems and therefore, although each user device individually has a low PAPR DMRS, when the DMRSs of different user devices are added together, the PAPR of the combined waveform increases. This process of DMRSs of different user devices adding together happens in the air after transmission, so the increased PAPR is not a problem for each user device individually. However, when two DMRSs are transmitted from the same user device, the higher PAPR caused by multiplexing can be a problem for the transmitter of the device.

In millimeter wavelength (“mm-Wave”) communications, for example, due to low power amplifier (PA) efficiency and high power consumption, a low PAPR waveform is even more desirable. In addition, when channel condition permits, a system may support a two-layer transmission for a specific user device, to be able to transmit two DMRSs, for example.

Conventionally multiplexed signals will have high PAPR when transmitted from the same device, even when each signal individually has a low PAPR. This issue is not limited to DMRSs, but may also be an issue for other types of signals such as signals carried by multiplexed beams for example. Providing for communication of low PAPR multiplexed signals with a single communication device remains a challenge.

### SUMMARY

Embodiments of the present disclosure relate to communication of low PAPR multiplexed signals, and related signal multiplexing and waveform techniques. It is particularly desirable that multiplexed signals such as two-layer DMRS have low PAPR. For example, low PAPR two-layer DMRS provides superior channel estimation performance due to the fact that a low PAPR waveform can be transmitted at higher power.

According to embodiments disclosed herein, multiplexed signals that are communicated by a single device have combined low PAPR. The signals are multiplexed by interleaving in the time domain. This is in contrast with conventional DMRS multiplexing in 5G NR, for example, in which the multiplexing is accomplished via superposition. In some examples of the present disclosure, two multiplexed signals form a single carrier offset quadrature amplitude modulation (SC-OQAM) waveform in the time domain, and will therefore keep the combined PAPR of the multiplexed signals low.

According to an aspect of the present disclosure, a method involves communicating, by a first communication device in a wireless communication network, signaling related to sub-sequences of a base sequence; and transmitting, in the wireless communication network by the first communication device to a second communication device, a multiplexed signal that multiplexes a plurality of signals that are based on respective ones of the sub-sequences.

Another method involves communicating signaling and receiving a multiplexed signal, by a second communication device in a wireless communication network. The signaling is related to sub-sequences of a base sequence. The multiplexed signal is received from a first communication device, and multiplexes a plurality of signals that are based on respective ones of the sub-sequences.

In apparatus embodiments, an apparatus may include a processor and a non-transitory computer readable storage medium that is coupled to the processor. The non-transitory computer readable storage medium stores programming for execution by the processor.

A storage medium need not necessarily or only be implemented in or in conjunction with such an apparatus. A computer program product, for example, may be or include a non-transitory computer readable medium storing programming for execution by a processor.

Programming stored by a computer readable storage medium may include instructions to, or to cause a processor to, perform, implement, support, or enable any of the methods disclosed herein.

For example, the programming may include instructions to, or to cause a processor to: communicate, by a first communication device in a wireless communication network, signaling related to sub-sequences of a base sequence; and transmit, in the wireless communication network by the first communication device to a second communication device, a multiplexed signal that multiplexes a plurality of signals that are based on respective ones of the sub-sequences.

The programming, in another embodiment, may include instructions to, or to cause a processor to: communicate, by a second communication device in a wireless communication network, signaling related to sub-sequences of a base sequence; and receive, in the wireless communication network by the second communication device from a first communication device, a multiplexed signal that multiplexes a plurality of signals that are based on respective ones of the sub-sequences.

In the above-referenced method, apparatus, and computer program product embodiments, the sub-sequences each comprise a unique subset of non-consecutive values from the base sequence, equally spaced apart by one or more zero values and at different positions within each of the sub-sequences. The plurality of signals comprise components that are equally spaced apart and at different positions within each of the signals such that consecutive components of the multiplexed signal comprise the components of different ones of the plurality of signals.

According to another aspect of the present disclosure, a system comprises a first communication device and a second communication device. The first communication device is configured to transmit a multiplexed signal comprising a plurality of signals. Each signal of the plurality of signals is based on a respective sub-sequence of a plurality of sub-sequences of a base sequence. The respective sub-sequence each comprises a unique subset of non-consecutive values from the base sequence, equally spaced apart by one or more zero values and at different positions within each of the sub-sequences. The plurality of signals comprise components that are equally spaced apart and at different positions within each of the signals such that consecutive components of the multiplexed signal comprise the components of different ones of the plurality of signals. The second communication device is configured to receive the multiplexed signal and process each of the plurality of signals of the multiplexed signal.

The present disclosure encompasses these and other aspects or embodiments.

### BRIEF DESCRIPTION OF THE DRAWINGS

For a more complete understanding of the present embodiments, and the advantages thereof, reference is now made, by way of example, to the following descriptions taken in conjunction with the accompanying drawings.

FIG. 1 is a simplified schematic illustration of a communication system.

FIG. 2 is a block diagram illustration of the example communication system in FIG. 1.

FIG. 3 illustrates an example electronic device and examples of base stations.

FIG. 4 illustrates units or modules in a device.

FIG. 5 is a time domain plot illustrating an example of a multiplexed signal that multiplexes two signals.

FIG. 6 is a block diagram illustrating a single beam based synchronization channel.

FIG. 7 is a block diagram illustrating a simultaneous multi-beam based synchronization channel.

FIG. 8 is a signal flow diagram for uplink communications according to an embodiment.

FIG. 9 is a signal flow diagram for downlink communications according to an embodiment.

FIG. 10 is a signal flow diagram for sidelink communications according to an embodiment.

FIG. 11 is a signal flow diagram for sidelink communications according to another embodiment.

FIG. 12 is a block diagram illustrating an example transmitter according to an embodiment.

FIG. 13 is a block diagram illustrating an example receiver according to an embodiment.

### DETAILED DESCRIPTION OF ILLUSTRATIVE EMBODIMENTS

For illustrative purposes, specific example embodiments will now be explained in greater detail in conjunction with the figures.

The embodiments set forth herein represent information sufficient to practice the claimed subject matter and illustrate ways of practicing such subject matter. Upon reading the following description in light of the accompanying figures, those of skill in the art will understand the concepts of the claimed subject matter and will recognize applications of these concepts not particularly addressed herein. It should be understood that these concepts and applications fall within the scope of the disclosure and the accompanying claims.

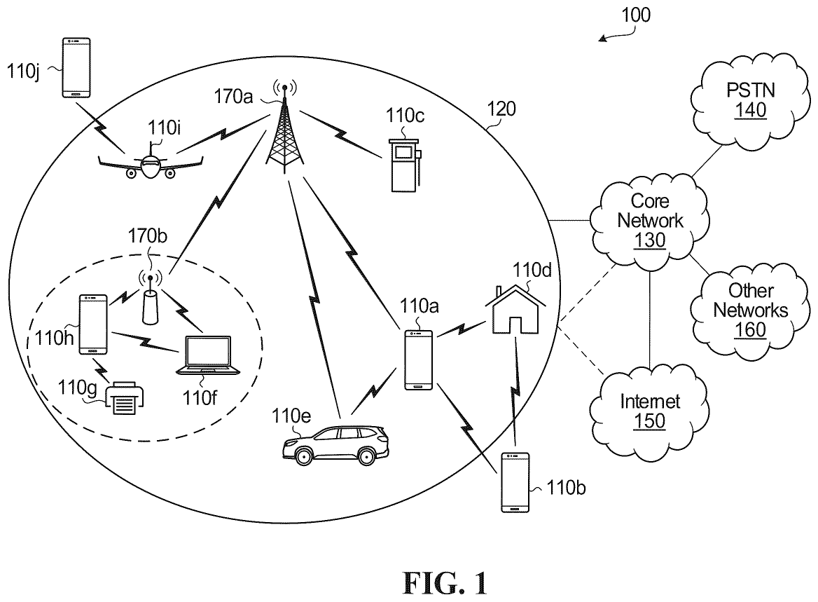

Referring to FIG. 1, as an illustrative example without limitation, a simplified schematic illustration of a communication system is provided. The communication system 100 comprises a radio access network 120. The radio access network 120 may be a next generation (e.g., sixth generation, “6G,” or later) radio access network, or a legacy (e.g., 5G, 4G, 3G or 2G) radio access network. One or more communication electric device (ED) 110a, 110b, 110c, 110d, 110e, 110f, 110g, 110h, 110i, 110j (generically referred to as no) may be interconnected to one another or connected to one or more network nodes (170a, 170b, generically referred to as 170) in the radio access network 120. A core network 130 may be a part of the communication system and may be dependent or independent of the radio access technology used in the communication system 100. Also, the communication system 100 comprises a public switched telephone network (PSTN) 140, the internet 150, and other networks 160.

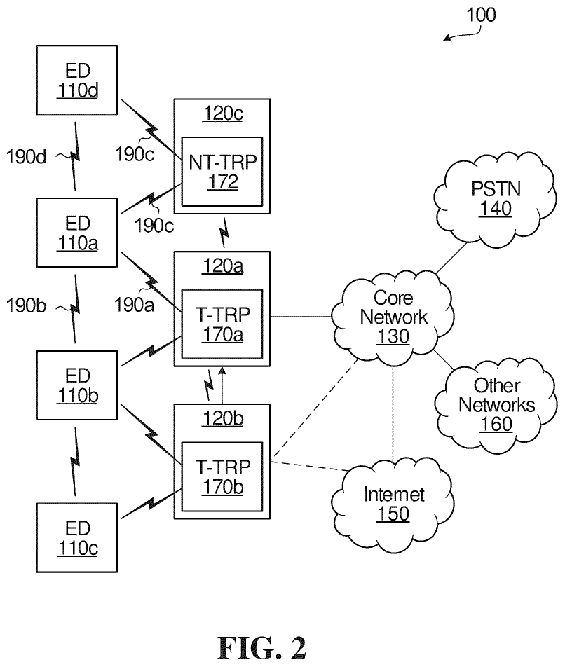

FIG. 2 illustrates an example communication system 100. In general, the communication system 100 enables multiple wireless or wired elements to communicate data and other content. The purpose of the communication system 100 may be to provide content, such as voice, data, video, and/or text, via broadcast, multicast and unicast, etc. The communication system 100 may operate by sharing resources, such as carrier spectrum bandwidth, between its constituent elements. The communication system 100 may include a terrestrial communication system and/or a non-terrestrial communication system. The communication system 100 may provide a wide range of communication services and applications (such as earth monitoring, remote sensing, passive sensing and positioning, navigation and tracking, autonomous delivery and mobility, etc.). The communication system 100 may provide a high degree of availability and robustness through a joint operation of a terrestrial communication system and a non-terrestrial communication system. For example, integrating a non-terrestrial communication system (or components thereof) into a terrestrial communication system can result in what may be considered a heterogeneous network comprising multiple layers. Compared to conventional communication networks, the heterogeneous network may achieve better overall performance through efficient multi-link joint operation, more flexible functionality sharing and faster physical layer link switching between terrestrial networks and non-terrestrial networks.

The terrestrial communication system and the non-terrestrial communication system could be considered sub-systems of the communication system. In the example shown in FIG. 2, the communication system 100 includes electronic devices (ED) 110a, 110b, 110c, 110d (generically referred to as ED 110), radio access networks (RANs) 120a, 120b, a non-terrestrial communication network 120c, a core network 130, a public switched telephone network (PSTN) 140, the Internet 150 and other networks 160. The RANs 120a, 120b include respective base stations (BSs) 170a, 170b, which may be generically referred to as terrestrial transmit and receive points (T-TRPs) 170a, 170b. The non-terrestrial communication network 120c includes an access node 172, which may be generically referred to as a non-terrestrial transmit and receive point (NT-TRP) 172.

Any ED 110 may be alternatively or additionally configured to interface, access, or communicate with any T-TRP 170a, 170b and NT-TRP 172, the Internet 150, the core network 130, the PSTN 140, the other networks 160, or any combination of the preceding. In some examples, the ED 110a may communicate an uplink and/or downlink transmission over a terrestrial air interface 190a with T-TRP 170a. In some examples, the EDs 110a, 110b, 110c and 110d may also communicate directly with one another via one or more sidelink air interfaces 190b. In some examples, the ED nod may communicate an uplink and/or downlink transmission over a non-terrestrial air interface 190c with NT-TRP 172.

The air interfaces 190a and 190b may use similar communication technology, such as any suitable radio access technology. For example, the communication system 100 may implement one or more channel access methods, such as code division multiple access (CDMA), space division multiple access (SDMA), time division multiple access (TDMA), frequency division multiple access (FDMA), orthogonal FDMA (OFDMA), or single-carrier FDMA (SC-FDMA) in the air interfaces 190a and 190b. The air interfaces 190a and 190b may utilize other higher dimension signal spaces, which may involve a combination of orthogonal and/or non-orthogonal dimensions.

The non-terrestrial air interface 190c can enable communication between the ED 110d and one or multiple NT-TRPs 172 via a wireless link or simply a link. For some examples, the link is a dedicated connection for unicast transmission, a connection for broadcast transmission, or a connection between a group of EDs 110 and one or multiple NT-TRPs 175 for multicast transmission.

The RANs 120a and 120b are in communication with the core network 130 to provide the EDs 110a, 110b, 110c with various services such as voice, data and other services. The RANs 120a and 120b and/or the core network 130 may be in direct or indirect communication with one or more other RANs (not shown), which may or may not be directly served by core network 130 and may, or may not, employ the same radio access technology as RAN 120a, RAN 120b or both. The core network 130 may also serve as a gateway access between (i) the RANs 120a and 120b or the EDs 110a, 110b, 110c or both, and (ii) other networks (such as the PSTN 140, the Internet 150, and the other networks 160). In addition, some or all of the EDs 110a, 110b, 110c may include functionality for communicating with different wireless networks over different wireless links using different wireless technologies and/or protocols. Instead of wireless communication (or in addition thereto), the EDs 110a, 110b, 110c may communicate via wired communication channels to a service provider or switch (not shown) and to the Internet 150. The PSTN 140 may include circuit switched telephone networks for providing plain old telephone service (POTS). The Internet 150 may include a network of computers and subnets (intranets) or both and incorporate protocols, such as Internet Protocol (IP), Transmission Control Protocol (TCP), User Datagram Protocol (UDP). The EDs 110a, 110b, 110c may be multimode devices capable of operation according to multiple radio access technologies and may incorporate multiple transceivers necessary to support such.

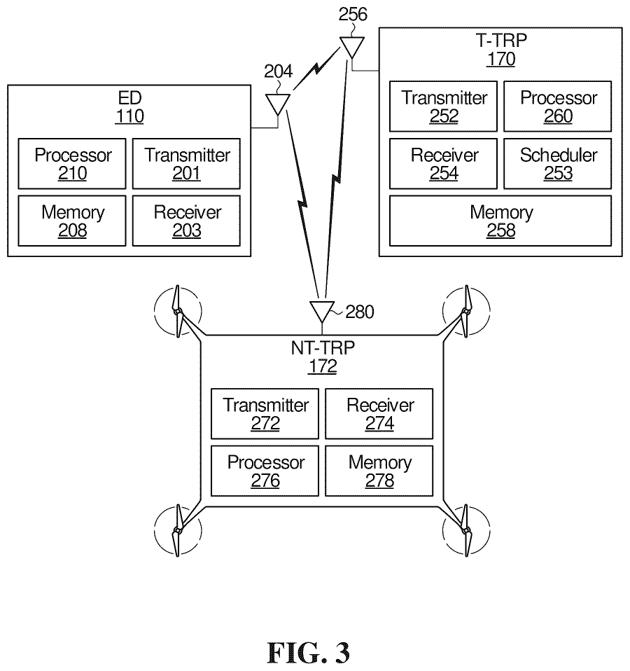

FIG. 3 illustrates another example of an ED no and a base station 170a, 170b and/or 170c. The ED no is used to connect persons, objects, machines, etc. The ED no may be widely used in various scenarios, for example, cellular communications, device-to-device (D2D), vehicle to everything (V2X), peer-to-peer (P2P), machine-to-machine (M2M), machine-type communications (MTC), Internet of things (IoT), virtual reality (VR), augmented reality (AR), industrial control, self-driving, remote medical, smart grid, smart furniture, smart office, smart wearable, smart transportation, smart city, drones, robots, remote sensing, passive sensing, positioning, navigation and tracking, autonomous delivery and mobility, etc.

Each ED 110 represents any suitable end user device for wireless operation and may include such devices (or may be referred to) as a user equipment/device (UE), a wireless transmit/receive unit (WTRU), a mobile station, a fixed or mobile subscriber unit, a cellular telephone, a station (STA), a machine type communication (MTC) device, a personal digital assistant (PDA), a smartphone, a laptop, a computer, a tablet, a wireless sensor, a consumer electronics device, a smart book, a vehicle, a car, a truck, a bus, a train, or an IoT device, an industrial device, or apparatus (e.g., communication module, modem, or chip) in the forgoing devices, among other possibilities. Future generation EDs 110 may be referred to using other terms. The base stations 170a and 170b each T-TRPs and will, hereafter, be referred to as T-TRP 170. Also shown in FIG. 3, a NT-TRP will hereafter be referred to as NT-TRP 172. Each ED 110 connected to the T-TRP 170 and/or the NT-TRP 172 can be dynamically or semi-statically turned-on (i.e., established, activated or enabled), turned-off (i.e., released, deactivated or disabled) and/or configured in response to one of more of: connection availability; and connection necessity.

The ED 110 includes a transmitter 201 and a receiver 203 coupled to one or more antennas 204. Only one antenna 204 is illustrated. One, some, or all of the antennas 204 may, alternatively, be panels. The transmitter 201 and the receiver 203 may be integrated, e.g., as a transceiver. The transceiver is configured to modulate data or other content for transmission by the at least one antenna 204 or by a network interface controller (NIC). The transceiver may also be configured to demodulate data or other content received by the at least one antenna 204. Each transceiver includes any suitable structure for generating signals for wireless or wired transmission and/or processing signals received wirelessly or by wire. Each antenna 204 includes any suitable structure for transmitting and/or receiving wireless or wired signals.

The ED 110 includes at least one memory 208. The memory 208 stores instructions and data used, generated, or collected by the ED 110. For example, the memory 208 could store software instructions or modules configured to implement some or all of the functionality and/or embodiments described herein and that are executed by one or more processing unit(s) (e.g., a processor 210). Each memory 208 includes any suitable volatile and/or non-volatile storage and retrieval device(s). Any suitable type of memory may be used, such as random access memory (RAM), read only memory (ROM), hard disk, optical disc, subscriber identity module (SIM) card, memory stick, secure digital (SD) memory card, on-processor cache and the like.

The ED 110 may further include one or more input/output devices (not shown) or interfaces (such as a wired interface to the Internet 150 in FIG. 1). The input/output devices permit interaction with a user or other devices in the network. Each input/output device includes any suitable structure for providing information to, or receiving information from, a user, such as through operation as a speaker, a microphone, a keypad, a keyboard, a display or a touch screen, including network interface communications.

The ED 110 includes the processor 210 for performing operations including those operations related to preparing a transmission for uplink transmission to the NT-TRP 172 and/or the T-TRP 170, those operations related to processing downlink transmissions received from the NT-TRP 172 and/or the T-TRP 170, and those operations related to processing sidelink transmission to and from another ED 110. Processing operations related to preparing a transmission for uplink transmission may include operations such as encoding, modulating, transmit beamforming and generating symbols for transmission. Processing operations related to processing downlink transmissions may include operations such as receive beamforming, demodulating and decoding received symbols. Depending upon the embodiment, a downlink transmission may be received by the receiver 203, possibly using receive beamforming, and the processor 210 may extract signaling from the downlink transmission (e.g., by detecting and/or decoding the signaling). An example of signaling may be a reference signal transmitted by the NT-TRP 172 and/or by the T-TRP 170. In some embodiments, the processor 210 implements the transmit beamforming and/or the receive beamforming based on the indication of beam direction, e.g., beam angle information (BAI), received from the T-TRP 170. In some embodiments, the processor 210 may perform operations relating to network access (e.g., initial access) and/or downlink synchronization, such as operations relating to detecting a synchronization sequence, decoding and obtaining the system information, etc. In some embodiments, the processor 210 may perform channel estimation, e.g., using a reference signal received from the NT-TRP 172 and/or from the T-TRP 170.

Although not illustrated, the processor 210 may form part of the transmitter 201 and/or part of the receiver 203. Although not illustrated, the memory 208 may form part of the processor 210.

The processor 210, the processing components of the transmitter 201 and the processing components of the receiver 203 may each be implemented by the same or different one or more processors that are configured to execute instructions stored in a memory (e.g., the in memory 208). Alternatively, some or all of the processor 210, the processing components of the transmitter 201 and the processing components of the receiver 203 may each be implemented using dedicated circuitry, such as a programmed field-programmable gate array (FPGA), a graphical processing unit (GPU), or an application-specific integrated circuit (ASIC).

The T-TRP 170 may be known by other names in some implementations, such as a base station, a base transceiver station (BTS), a radio base station, a network node, a network device, a device on the network side, a transmit/receive node, a Node B, an evolved NodeB (eNodeB or eNB), a Home eNodeB, a next Generation NodeB (gNB), a transmission point (TP), a site controller, an access point (AP), a wireless router, a relay station, a remote radio head, a terrestrial node, a terrestrial network device, a terrestrial base station, a base band unit (BBU), a remote radio unit (RRU), an active antenna unit (AAU), a remote radio head (RRH), a central unit (CU), a distribute unit (DU), a positioning node, among other possibilities. The T-TRP 170 may be a macro BS, a pico BS, a relay node, a donor node, or the like, or combinations thereof. The T-TRP 170 may refer to the forgoing devices or refer to apparatus (e.g., a communication module, a modem or a chip) in the forgoing devices.

In some embodiments, the parts of the T-TRP 170 may be distributed. For example, some of the modules of the T-TRP 170 may be located remote from the equipment that houses antennas 256 for the T-TRP 170, and may be coupled to the equipment that houses antennas 256 over a communication link (not shown) sometimes known as front haul, such as common public radio interface (CPRI). Therefore, in some embodiments, the term T-TRP 170 may also refer to modules on the network side that perform processing operations, such as determining the location of the ED 110, resource allocation (scheduling), message generation, and encoding/decoding, and that are not necessarily part of the equipment that houses antennas 256 of the T-TRP 170. The modules may also be coupled to other T-TRPs. In some embodiments, the T-TRP 170 may actually be a plurality of T-TRPs that are operating together to serve the ED 110, e.g., through the use of coordinated multipoint transmissions.

The T-TRP 170 includes at least one transmitter 252 and at least one receiver 254 coupled to one or more antennas 256. Only one antenna 256 is illustrated. One, some, or all of the antennas 256 may, alternatively, be panels. The transmitter 252 and the receiver 254 may be integrated as a transceiver. The T-TRP 170 further includes a processor 260 for performing operations including those related to: preparing a transmission for downlink transmission to the ED 110; processing an uplink transmission received from the ED 110; preparing a transmission for backhaul transmission to the NT-TRP 172; and processing a transmission received over backhaul from the NT-TRP 172. Processing operations related to preparing a transmission for downlink or backhaul transmission may include operations such as encoding, modulating, precoding (e.g., multiple input multiple output (MIMO) precoding), transmit beamforming and generating symbols for transmission. Processing operations related to processing received transmissions in the uplink or over backhaul may include operations such as receive beamforming, demodulating received symbols and decoding received symbols. The processor 260 may also perform operations relating to network access (e.g., initial access) and/or downlink synchronization, such as generating the content of synchronization signal blocks (SSBs), generating the system information, etc. In some embodiments, the processor 260 also generates an indication of beam direction, e.g., BAI, which may be scheduled for transmission by a scheduler 253. The processor 260 performs other network-side processing operations described herein, such as determining the location of the ED 110, determining where to deploy the NT-TRP 172, etc. In some embodiments, the processor 260 may generate signaling, e.g., to configure one or more parameters of the ED 110 and/or one or more parameters of the NT-TRP 172. Any signaling generated by the processor 260 is sent by the transmitter 252. Note that “signaling,” as used herein, may alternatively be called control signaling. Dynamic signaling may be transmitted in a control channel, e.g., a physical downlink control channel (PDCCH) and static, or semi-static, higher layer signaling may be included in a packet transmitted in a data channel, e.g., in a physical downlink shared channel (PDSCH).

The scheduler 253 may be coupled to the processor 260. The scheduler 253 may be included within, or operated separately from, the T-TRP 170. The scheduler 253 may schedule uplink, downlink and/or backhaul transmissions, including issuing scheduling grants and/or configuring scheduling-free (“configured grant”) resources. The T-TRP 170 further includes a memory 258 for storing information and data. The memory 258 stores instructions and data used, generated, or collected by the T-TRP 170. For example, the memory 258 could store software instructions or modules configured to implement some or all of the functionality and/or embodiments described herein and that are executed by the processor 260.

Although not illustrated, the processor 260 may form part of the transmitter 252 and/or part of the receiver 254. Also, although not illustrated, the processor 260 may implement the scheduler 253. Although not illustrated, the memory 258 may form part of the processor 260.

The processor 260, the scheduler 253, the processing components of the transmitter 252 and the processing components of the receiver 254 may each be implemented by the same, or different one of, one or more processors that are configured to execute instructions stored in a memory, e.g., in the memory 258. Alternatively, some or all of the processor 260, the scheduler 253, the processing components of the transmitter 252 and the processing components of the receiver 254 may be implemented using dedicated circuitry, such as a FPGA, a GPU or an ASIC.

Notably, the NT-TRP 172 is illustrated as a drone only as an example, the NT-TRP 172 may be implemented in any suitable non-terrestrial form. Also, the NT-TRP 172 may be known by other names in some implementations, such as a non-terrestrial node, a non-terrestrial network device, or a non-terrestrial base station. The NT-TRP 172 includes a transmitter 272 and a receiver 274 coupled to one or more antennas 280. Only one antenna 280 is illustrated. One, some, or all of the antennas may alternatively be panels. The transmitter 272 and the receiver 274 may be integrated as a transceiver. The NT-TRP 172 further includes a processor 276 for performing operations including those related to: preparing a transmission for downlink transmission to the ED 110; processing an uplink transmission received from the ED 110; preparing a transmission for backhaul transmission to T-TRP 170; and processing a transmission received over backhaul from the T-TRP 170. Processing operations related to preparing a transmission for downlink or backhaul transmission may include operations such as encoding, modulating, precoding (e.g., MIMO precoding), transmit beamforming and generating symbols for transmission. Processing operations related to processing received transmissions in the uplink or over backhaul may include operations such as receive beamforming, demodulating received signals and decoding received symbols. In some embodiments, the processor 276 implements the transmit beamforming and/or receive beamforming based on beam direction information (e.g., BAI) received from the T-TRP 170. In some embodiments, the processor 276 may generate signaling, e.g., to configure one or more parameters of the ED 110. In some embodiments, the NT-TRP 172 implements physical layer processing but does not implement higher layer functions such as functions at the medium access control (MAC) or radio link control (RLC) layer. As this is only an example, more generally, the NT-TRP 172 may implement higher layer functions in addition to physical layer processing.

The NT-TRP 172 further includes a memory 278 for storing information and data. Although not illustrated, the processor 276 may form part of the transmitter 272 and/or part of the receiver 274. Although not illustrated, the memory 278 may form part of the processor 276.

The processor 276, the processing components of the transmitter 272 and the processing components of the receiver 274 may each be implemented by the same or different one or more processors that are configured to execute instructions stored in a memory, e.g., in the memory 278. Alternatively, some or all of the processor 276, the processing components of the transmitter 272 and the processing components of the receiver 274 may be implemented using dedicated circuitry, such as a programmed FPGA, a GPU or an ASIC. In some embodiments, the NT-TRP 172 may actually be a plurality of NT-TRPs that are operating together to serve the ED 110, e.g., through coordinated multipoint transmissions.

The T-TRP 170, the NT-TRP 172, and/or the ED 110 may include other components, but these have been omitted for the sake of clarity.

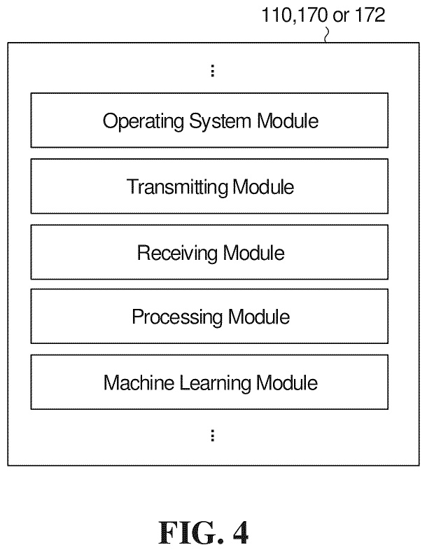

One or more steps of the embodiment methods provided herein may be performed by corresponding units or modules, according to FIG. 4. FIG. 4 illustrates units or modules in a device, such as in the ED 110, in the T-TRP 170 or in the NT-TRP 172. For example, a signal may be transmitted by a transmitting unit or by a transmitting module. A signal may be received by a receiving unit or by a receiving module. A signal may be processed by a processing unit or a processing module. Other steps may be performed by an artificial intelligence (AI) or machine learning (ML) module. The respective units or modules may be implemented using hardware, one or more components or devices that execute software, or a combination thereof. For instance, one or more of the units or modules may be an integrated circuit, such as a programmed FPGA, a GPU or an ASIC. It will be appreciated that where the modules are implemented using software for execution by a processor, for example, the modules may be retrieved by a processor, in whole or part as needed, individually or together for processing, in single or multiple instances, and that the modules themselves may include instructions for further deployment and instantiation.

Additional details regarding the EDs 110, the T-TRP 170 and the NT-TRP 172 are known to those of skill in the art. As such, these details are omitted here.

Having considered communications more generally above, attention will now turn to particular example embodiments.

According to embodiments disclosed herein, multiplexed signals that are communicated by a single device have combined low PAPR. The signals are multiplexed by interleaving in the time domain. This is in contrast with conventional DMRS multiplexing in 5G NR, for example, in which the multiplexing is accomplished via superposition.

Multiplexed signals communicated by a single device may be referred to as multi-port (such as dual-port in the case of two signals), multi-antenna port (such as dual-antenna port in the case of two signals), or multi-beam (such as dual-beam in the case of two signals) signals that are respectively associated with different ports, antenna ports, or beams. A port or antenna port is a logical construct, and is defined such that the channel over which a symbol on the antenna port is conveyed can be inferred from the channel over which another symbol on the same antenna port is conveyed. In other words, in some embodiments each port may have its own UE-specific DMRS. The concept of a layer may also be relevant to multiplexed signals, and different signals that are to be multiplexed may be associated with different layers. A layer tends to refer to a single-user MIMO concept, in respect of how many layers or streams of data can be simultaneously transmitted in space. A beam is often, but not necessarily always, associated with a layer, in the sense that each layer may have its own associated beam, in closed-loop MIMO for example. Port, layer, and beam may be inter-related features or concepts in that one antenna port may have its own beam direction, use its own DMRS, and transmit one layer of data. A “layer of data” that is known at both a transmitter and a receiver may be used as a synchronization signal or a DMRS signal, for example.

In a sense, a layer may be considered a physical concept or construct, whereas a port or beam may be considered a logical concept or construct. These features may also be inter-related, in that there may be a mapping between layers and ports or layers and beams. For example, a signal associated with a layer may be carried by a channel or link that is provided or supported by a port or beam. In some embodiments, there is a one-to-one mapping between layers and ports or beams, such that any one port or beam carries signals associated with one layer, and signals associated with any one layer are carried by one port or beam. This is not necessarily the case in all embodiments, and several ports or beams may transport signals associated with the same layer, for example.

Regardless of whether the signals that are to be multiplexed are associated with different ports, beams, or layers, the multiplexed signals are to be communicated with a single communication device. Communicating multiplexed signals with a communication device may include transmitting the multiplexed signals by the communication device, and/or receiving the multiplexed signals from the communication device, for example.

In one embodiment of a time domain interleaving approach consistent with the present disclosure, two multiplexed signals form a single carrier offset quadrature amplitude modulation (SC-OQAM) waveform in the time domain, and will therefore keep the combined PAPR of the multiplexed signals low. Although the present disclosure is not in any way limited to multiplexing any particular number of signals, this SC-OQAM property is illustrative of a benefit that may be provided in particular embodiments, and in this example for multiplexing two signals.

The present disclosure also is not limited to particular types of signals. Some embodiments are described by way of example in the context of multiplexed DMRSs, but features disclosed in this context may also or instead be applied to other types of signals. Put another way, DMRSs can be substituted with data streams for different signals, including but not limited to synchronization signals for example.

Signals that are to be multiplexed may, but need not necessarily, all be of the same type. Low PAPR may be of greater importance for certain types of signals, and in some embodiments signals of the same type are multiplexed, but multiplexing of signals as disclosed herein is not dependent upon signal type.

Solely for the purpose of illustration, consider an embodiment related to two DMRSs that are to be multiplexed, including one DMRS for each of two ports. Generating the DMRSs may involve generating or otherwise obtaining a sequence, such as a Gold sequence or a ZC sequence, for example, of length N/2, c₀, c₁, C_{N/2-1}, where N is a number of frequency subcarriers occupied by the two ports.

Gold sequences may be particularly preferred because they have a relatively flat power spectrum, which is desirable for channel estimation. ZC sequences also have a flat power spectrum, but a higher PAPR in the up-sampled time signal. Generally speaking, any sequence with a relatively flat power spectrum may suffice for DMRS generation. A binary sequence such as Gold sequence, however, can be used to construct an SC-OQAM signal when the number of ports, or more generally the number of signals to be multiplexed, is two. SC-OQAM has the lowest PAPR of single-carrier waveforms.

A binary sequence inserted in the time domain may be used with π/2-BPSK modulation. One purpose of using a Gold sequence with π/2-BPSK modulation is to provide a reference signal with lower PAPR than a reference signal that is based on ZC sequences. The main differences between Gold sequence-generated reference signals (RSs) and ZC sequence-generated RSs are that Gold sequence-generated RSs has even lower PAPR but non-flat power spectrum in the frequency domain, which makes it suitable for lower order modulations such as π/2-BPSK modulation.

This discussion of sequences alludes to a next step in generating DMRSs, which is applying π/2-BPSK modulation to the selected sequence to generate a modulated sequence [symbol] =[s₀ s₁ . . . s_{N/2-1}].

Two length N/2 sequences are then formed from [symbol] _{N/2}:

$$\begin{matrix}{\vec{s}}_{N / 2}^{( 0 )} = [ {s}_{0} 0 {s}_{2} … {s}_{N / 2 - 2} 0 ] \\ {\vec{s}}_{N / 2}^{( 1 )} = [ 0 {s}_{1} 0 … 0 {s}_{N / 2 - 2} ] .\end{matrix}$$

In the context of this illustrative example, two DMRSs are then generated, including:

$$\begin{matrix}{\vec{s}}^{( 0 )} = [ {\vec{s}}_{N / 2}^{( 0 )} {\vec{s}}_{N / 2}^{( 0 )} ] and \\ {\vec{s}}^{( 1 )} = [ {\vec{s}}_{N / 2}^{( 1 )} - {\vec{s}}_{N / 2}^{( 1 )} ] ,\end{matrix}$$

for port-0 and port-1, respectively, in a dual-port embodiment with one DMRS per port.

In this way, two DMRS sequences form a “comb” structure in both the time domain and the frequency domain. In addition, [symbol] ⁽⁰⁾ is real and [symbol] ⁽¹⁾ is imaginary in this example, and the time domain multiplexed DMRSs form an SC-OQAM signal, which further lowers PAPR.

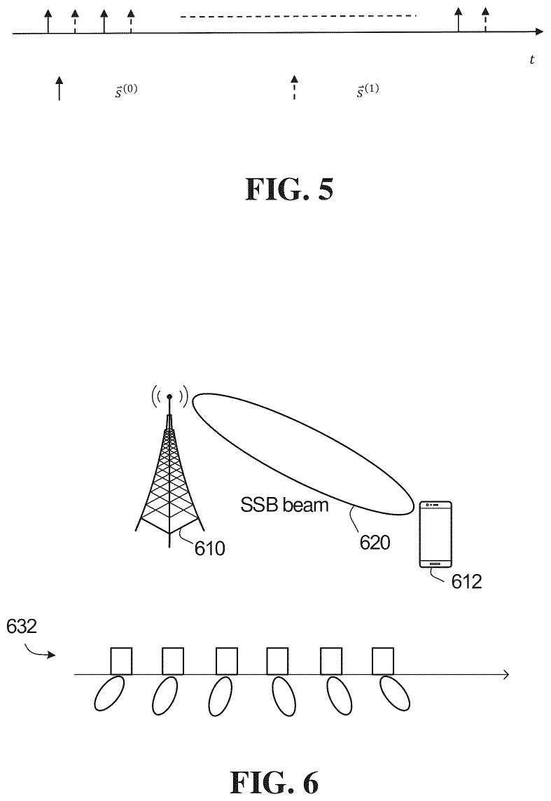

FIG. 5 is a time domain plot illustrating an example of a multiplexed signal that multiplexes two signals, and shows that the resulting waveform multiplexes signals that have a comb structure in the time domain. As used herein, a comb structure is intended to convey the notion of non-zero values being non-consecutive or non-contiguous, in time domain or frequency domain. Stated another way, in a sequence or signal that has a comb structure, any two adjacent non-zero values or elements are separated by one or more zero values or elements. Signals that are to be multiplexed have what may be referred to as complementary comb structures, in that positions or locations in one signal that have been set to zero have not been set to zero in at least one other signal. In FIG. 5, for example, [symbol] ⁽⁰⁾ and [symbol] ⁽¹⁾ have complementary comb structures, and a multiplexed signal may be referred to as having a double comb structure in this example. In higher-order multiplexing of more than two sequences or signals, non-zero values or elements in each sequence or signal are separated by multiple values or elements that have been set to zero, and at any index or position in time or frequency only one of the sequences or signals has a value that has not been set to zero.

From this example and the above discussion, it can be seen that low PAPR of two multiplexed DMRSs may be achieved in an embodiment by the following two considerations:
DMRSs, from two ports for example, are offset from each other but interleaved with each other in the time-domain;
DMRS sequences generated from the same binary sequence such as a Gold sequence provide flatter frequency response, and in some embodiments one modulated sequence includes real-value elements and another includes imaginary-value elements, in the time domain.

Although the first consideration above can be ensured with a comb signal structure as disclosed herein, the second consideration is not strictly guaranteed in MIMO. This is because in MIMO, a transmitted signal is transformed by a pre-coder. Pre-coder elements for the same power amplifier (PA) may rotate multiplexed signals with different angles, and phases in pre-coder elements can change along the i-axis. These two factors can make multiplexed sequences deviate from π/2 consecutive phase rotations in the time sequences at each PA input. Nevertheless, when consecutive phase rotations are still close to π/2 (the worst case is in-phase), the PAPR of multiplexed DMRSs can still be reduced. Furthermore, by setting one pair of corresponding pre-coder elements to o phase, at least that corresponding PA can have strict π/2 phase rotations. This is because only relative phases in the pre-coder are important, and therefore applying a common phase to them does not affect system performance. This property can be exploited when one PA has higher power than others, due to beam-forming requirements for example.

Several embodiments disclosed herein refer to two multiplexed signals, for a dual-port design for example. However, other embodiments may extend to more than two multiplexed signals, for more than two ports for example, to provide an interleaved comb type of signal structure in the time domain, and the frequency domain.

Consider again a multiplexed DMRS embodiment, with one DMRS for each of multiple ports, as an illustrative example.

The process of generating multiplexed DMRSs may involve generating or otherwise obtaining a sequence, such as a Gold sequence or a ZC sequence, for example, of length L=N/M, c₀, c₁, . . . , c_{L-1}, where N is a number of frequency subcarriers occupied by the multiple ports and M is the number of ports.

Applying π/2-BPSK modulation to the sequence generates a modulated sequence [symbol] =[s₀ s₀ . . . s_{L-1}].

M sequences, each of length L, may then be formed from [symbol] _{L}:

$${\vec{s}}_{L}^{( m )} = [ 0 … {s}_{m} 0 … {s}_{m + M} 0 … {s}_{m + ( K - 1 ) M} 0 … ]$$

where m=0, 1, . . . , M−1 is a port index (or more generally a signal index), and K=L/M. Although this formula includes one or more leading zero values and one or more trailing zero values, this is intended only in order to provide a general formula for illustrative purposes. It is believed to be evident that a non-zero value appears at the first sequence position in the sequence for m=0, and at the last sequence position in the sequence for m=M−1.

In this illustrative example, respective DMRSs are then generated, including:

$${\vec{s}}^{( m )} = [ {\vec{s}}_{L}^{( m )} {e}^{j 2 π m / M} {\vec{s}}_{L}^{( m )} … {e}^{j 2 π ( M - 1 ) m / M} {\vec{s}}_{L}^{( m )} ] ,$$

for ports m=0, 1, . . . , M−1, in a multi-port embodiment with one DMRS per port.

The resultant multiplexed signal that multiplexes the DMRSs will have slightly higher PAPR than in the dual-port DMRS example, because adjacent pulses will not have a phase relation of ±π/2. However, the PAPR will still be smaller than conventional discrete Fourier transform spread OFDM (DFT-s-OFDM), because adjacent pulses are not in-phase.

Embodiments disclosed herein may be particularly beneficial for low PAPR multiplexed DMRSs, in applications for multi-port DMRS associated with the same device for uplink, downlink, and/or UE-to-UE communications over a sidelink for example. Another application in which disclosed embodiments may also or instead be of benefit is for simultaneous synchronization (synch) channel, such as simultaneous multi-beam based synch channel for downlink and/or UE-to-UE communications.

Beam sweeping may be used, for example, when beamforming is applied to a synchronization channel, to enable initial network access for UEs in different locations. However, beam sweeping may involve additional overhead and access delay, especially for higher frequency beam sweeping with narrow beams and larger antenna arrays. Wide beams can be used to reduce beam sweeping times for non-coverage limited scenarios, but spatial resolution is reduced relative to beam sweeping with narrower beams.

Simultaneous multi-beam based synch channels as disclosed herein can reduce beam sweeping overhead and also provide narrow beam resolution. When multi-beam signals share the same PA, PAPR is an issue. Several of the examples above refer to port index, and port index may in effect be replaced with beam index in embodiments to enable beam pair or beam group based synchronization channels. Low PAPR multiplexed multi-beam synch signals enable wide beam coverage for beam scanning, but with more accurate spatial resolution and without PAPR degradation. Similar to DMRS embodiments, different sequences may be formed from one base sequence in such a way that a comb type signal structure is provided in the time domain and the frequency domain. The difference from DMRS embodiments is that the different sequences are associated with different narrow beams for beam sweeping, to allow more accurate beam identification during simultaneous beam pair or beam group based beam sweeping. References to beam group are intended to encompass multiple beams, and a beam pair is one example of a beam group, including two beams. A beam group may include two, or more than two, beams.

In short, according to some embodiments, multiplexed synchronization signal block (SSB) beams are used for beam sweeping, instead of a wider beam, so that a higher beam resolution can be achieved with low PAPR multiplexed beams.

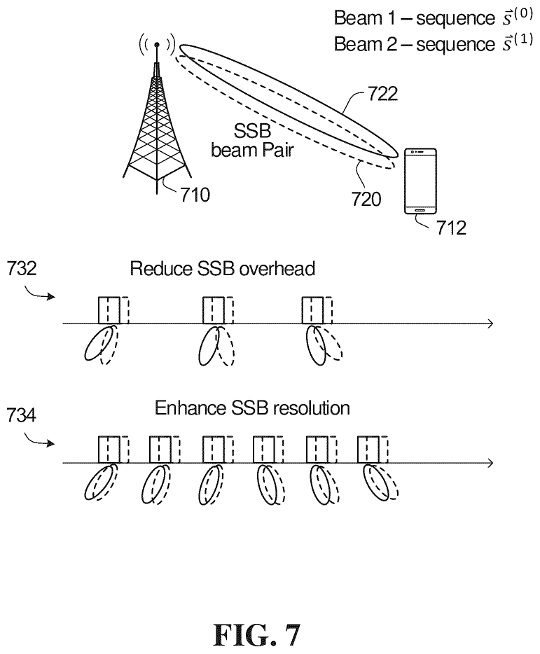

FIG. 6 is a block diagram illustrating a single beam based synch channel, and FIG. 7 is a block diagram illustrating a simultaneous multi-beam based synch channel.

FIG. 6 illustrates conventional beam sweeping between a network device 610 and a UE 612, in which a wider beam 620 is typically used to reduce sweeping time. Beam sweeping through different directions at different times is shown at 632. However, wider beams have lower beam resolution, also referred to herein as spatial resolution. From a system performance point of view, it would be desirable for a network device such as a gNB to use a beam of finer resolution to transmit data to a UE. Although a network device can potentially use multiple narrower beams to form a wider beam so that it can reduce beam sweeping time while keeping the beam resolution of the narrower beams, multiplexing multiple beams into a wider beam can cause PAPR to increase.

According to embodiments herein, beams are in effect multiplexed in a doubly combed way, similar to multiplexing of DMRSs, so as to maintain low PAPR of a single wide beam. As shown in FIG. 7 for a dual-beam embodiment by way of example, an SSB beam pair 720, 722 is used for beam sweeping between a network device 740 and a UE 712. Examples of beam sweeping patterns are shown at 732, 734. A pattern such as the pattern 732 can potentially reduce SSB overhead, and also or instead beam sweeping time, by sweeping through six different beam directions in three time occasions, instead of the six time occasions at 632 in FIG. 6. The example pattern at 734 illustrates that narrower beams may also or instead be used to provide enhanced SSB resolution. In comparison with the pattern shown at 632 in FIG. 6, the pattern at 734 in FIG. 7 implements beam sweeping at six occasions, but provides higher spatial resolution than the wider beam sweeping in FIG. 6.

Respective different sequences may be associated with different beams, as shown in FIG. 7, and these sequences may be generated in any of various ways, including examples similar to those provided herein for DMRS multiplexing. For a simultaneous dual-beam embodiment, for example, a sequence such as a Gold sequence or a ZC sequence of length N/2, c₀, c₁, . . . , c_{N/2-1} may be generated or otherwise obtained, where N is a number of frequency subcarriers carried by the two beams and π/2-BPSK modulation may be applied to that sequence to generate a modulated sequence [symbol] =[s₀ s₁ . . . s_{N/2-1}]. Two length N/2 sequences may then be formed from [symbol] :

$$\begin{matrix}{\vec{s}}_{N / 2}^{( 0 )} = [ {s}_{0} 0 {s}_{2} … {s}_{N / 2 - 2} 0 ] \\ {\vec{s}}_{N / 2}^{( 1 )} = [ 0 {s}_{1} 0 … 0 {s}_{N / 2 - 1} ] ,\end{matrix}$$

and the following beam sequences as shown in FIG. 7 are then generated:

$$\begin{matrix}{\vec{s}}^{( 0 )} = [ {\vec{s}}_{N / 2}^{( 0 )} {\vec{s}}_{N / 2}^{( 0 )} ] and \\ {\vec{s}}^{( 0 )} = [ {\vec{s}}_{N / 2}^{( 1 )} {\vec{s}}_{N / 2}^{( 1 )} ] ,\end{matrix}$$

for beam 1 and beam 2, respectively.

Like the dual-port DMRS example above, features related to a simultaneous dual-beam synch channel may be extended to multi-beam embodiments that involve more than two beams. Generating respective SSB signals for different beams may involve generating or otherwise obtaining a sequence, such as a Gold sequence or a ZC sequence, for example, of length L=N/M_{b}, c₀, c₁, . . . , c_{L-1}, where N is a number of frequency subcarriers carried by the multiple beams and M_{b} is the number of beams. Applying π/2-BPSK modulation to the sequence generates a modulated sequence [symbol] =[s₀ s₁ . . . s_{L-1}], and M_{b} sequences, each of length L, may then be formed from [symbol] :

$${\vec{s}}_{L}^{( m )} = [ 0 … {s}_{m} 0 … {s}_{m + {M}_{b}} 0 … {s}_{m + ( K - 1 ) {M}_{b}} 0 … ]$$

where m=0, 1, . . . , M_{b}−1 is a beam index, and K=L/M_{b}.

In this illustrative example, respective DMRSs are then generated, including:

$${\vec{s}}^{( m )} = [ {\vec{s}}_{L}^{( m )} {e}^{j 2 π m / {M}_{b}} {\vec{s}}_{L}^{( m )} … {e}^{j 2 π ( {M}_{b} - 1 ) m / {M}_{b}} {\vec{s}}_{L}^{( m )} ] ,$$

for beam m=0, 1, . . . , M−1, in a multi-beam embodiment with one SSB signal per beam.

The multi-port DMRS example above refers to M as a number of ports, and the multi-beam SSB example above refers to M_{b} as a number of beams. The different notation between these examples is only for ease of reference. More generally, M and M_{b} can be considered examples of a signal index, and the signal index may be an antenna port, antenna beam, layer, or other index, depending on the feature (port, beam, or layer in these examples) for which different sequences and signals are provided.

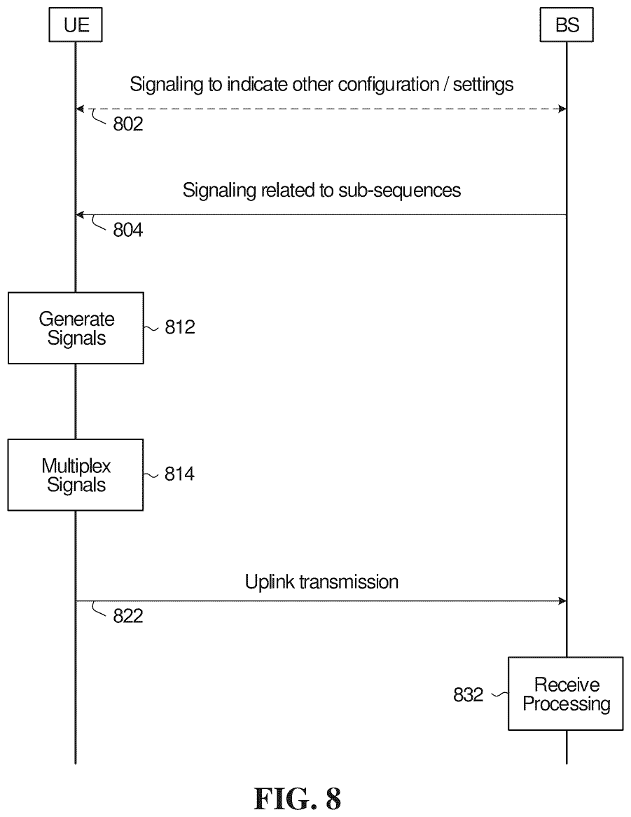

FIG. 8 is a signal flow diagram for uplink communications according to an embodiment. Features illustrated in FIG. 8 include communicating signaling at 804, between a first communication device and a second communication device, in the form of a BS and a UE in the example shown. This communicating at 804 involves transmitting the signaling by the BS to the UE and receiving the signaling by the UE from the BS. The signaling is related to sub-sequences of a base sequence, and may take any of various forms.

For example, the signaling at 804 may indicate a base sequence from which multiple sub-sequences, for generating DMRSs or synch signals for instance, are to be generated or formed. Such signaling is related to sub-sequences in that the sub-sequences are to be generated or formed from the base sequence, and therefore signaling that is indicative of a base sequence is also related to sub-sequences in at least this sense.

One or more base sequences may instead be pre-defined or pre-configured, and therefore need not be indicated in signaling at 804. In such embodiments, the signaling at 804 may be indicative of other characteristics or parameters related to sub-sequences. For example, the signaling at 804 may be indicative of any one or more of: a number of ports for which signals are to be multiplexed; allocated bandwidth, from which sequence length may be inferred or determined; and beam indices, from which the number of signals that are to be multiplexed may be inferred or determined, for beam sweeping embodiments.

These are illustrative and non-limiting examples of signaling that is related to sub-sequences. Other embodiments are possible, and may use similar or different signaling that is in some way related to sub-sequences upon which signals that are to be multiplexed are based. Specific types of signaling are also not necessarily mutually exclusive. For example, signaling related to sub-sequences may be or include signaling that is indicative of a base sequence, such as base sequence type and/or base sequence length, and one or more other parameters related to sub-sequences such as a number of ports or another indicator of a number of sub-sequences.

Other, optional signaling is illustrated at 802. The signaling at 802 indicates other configuration information and/or settings, and may be transmitted by the UE to the BS and received by the BS from the UE, and/or transmitted by the BS to the UE and received by the UE from the BS, as indicated by the bidirectional arrow at 802.

At 812, FIG. 8 illustrates generating signals by the UE. These signals are based on sub-sequences of a base sequence as disclosed herein, and non-limiting examples of signals include DMRSs and synch signals. Other types of signals are also possible, such as sounding reference signals (SRSs), which can benefit from a low PAPR multiplexed waveform when there are multiple antennas for which channel sounding is needed, for example. Generating signals at 812 may involve, for example, generating or otherwise obtaining a base sequence such as a Gold sequence or a ZC sequence, and such obtaining encompasses accessing a pre-defined or pre-configured base sequence that is available at a communication device. In some embodiments, modulation such as π/2-BPSK modulation is applied to the base sequence to generate a modulated base sequence. Multiple sub-sequences may be selected, formed, or otherwise obtained based on the (possibly modulated) base sequence, and signals that are to be multiplexed are based on the sub-sequences. Examples of such signals include DMRSs, synch signals, and SRSs, but other types of signals are also possible.

Multiplexing of the signals by the UE is illustrated at 814 in FIG. 8, and the multiplexed signals are transmitted by the UE and received by the BS at 822. Receive processing by the BS is illustrated at 832, and may involve performing channel estimation based on DMRSs or performing synchronization operations based on synch signals, for example.

Uplink transmission from a UE to a BS as shown at 822 represents one example of how a multiplexed signal that multiplexes a number of different signals may be communicated in a wireless communication network. In this example, communicating the multiplexed signal involves transmitting the multiplexed signal by the UE to the BS and receiving the multiplexed signal by the BS from the UE.

The manner in which a multiplexed signal is communicated is implementation-dependent. For example, transmission in a DFT-s-OFDM approach involves converting signals that are to be multiplexed from time domain to frequency domain, mapping to subcarriers, converting back to time domain, and inserting a CP to generate a time domain multiplexed signal for transmission. Thus, transmitting a multiplexed signal may involve these and/or other transmit processing operations, and similarly receiving a multiplexed signal may involve counterpart receive processing operations. Transmit processing is not shown in FIG. 8 or other drawings in order to avoid further congestion in the drawings.

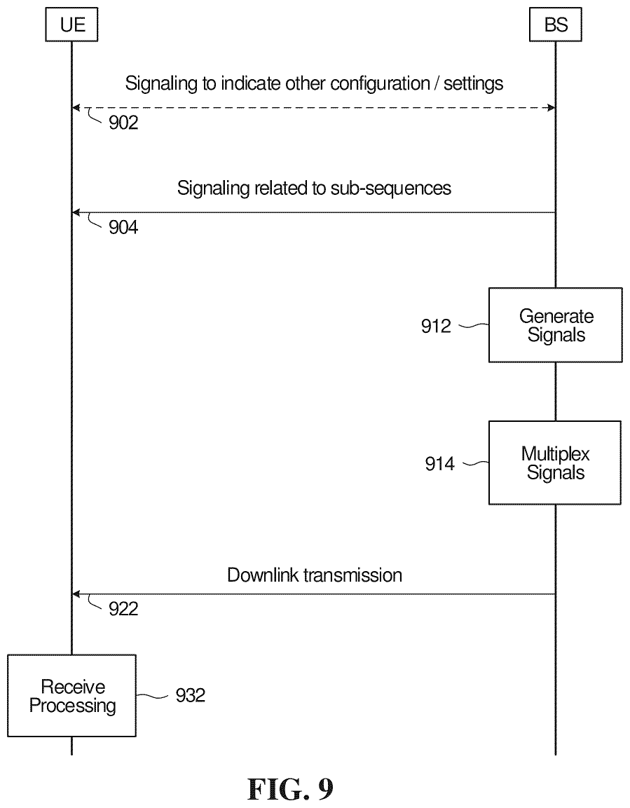

FIG. 9 is a signal flow diagram for downlink communications according to an embodiment. The example in FIG. 9 is similar to the example in FIG. 8, but involves generating signals at 912 by the BS, multiplexing the signals at 914 by the BS, and communicating a multiplexed signal in a downlink transmission at 922. Receive processing is also shown in FIG. 9 at 932, but FIG. 9 involves the UE receiving a multiplexed signal from the BS and performing receive processing. The signaling at 902, 904 in FIG. 9 may be the same or substantially the same as the signaling at 802, 804 in FIG. 8.

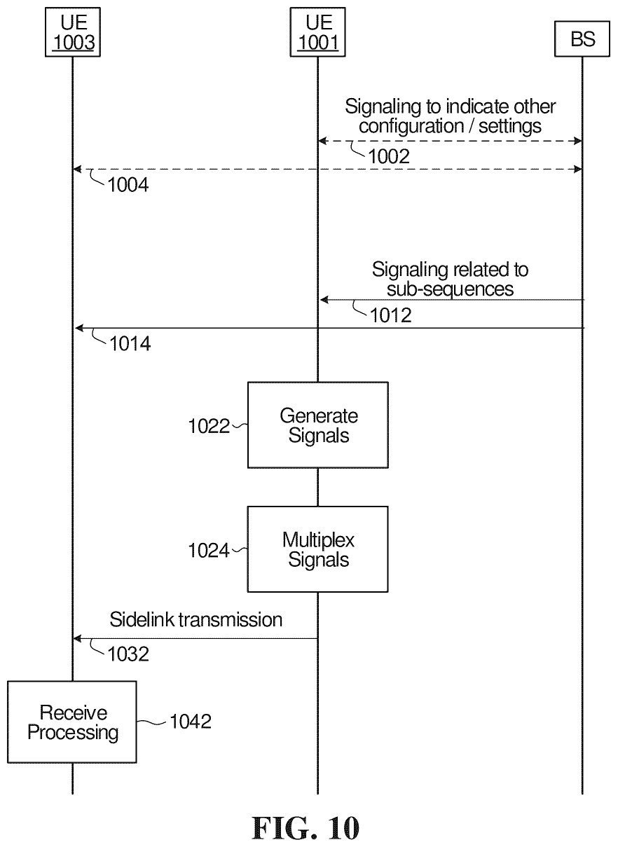

FIG. 10 is a signal flow diagram for sidelink communications according to an embodiment. Embodiments disclosed herein are not limited to communicating multiplexed signals between particular types of communication devices such as a UE and a BS as shown by way of example in FIGS. 8 and 9. UE-to-UE communications, as shown by way of example in FIG. 10 as sidelink communications, are possible.

Optional signaling between each of two UEs 1001, 1003 and a BS are shown at 1002, 1004. This optional signaling is described at least above with reference to 802 in FIG. 8, but in FIG. 10 this signaling is communicated between each UE 1001, 1003 and the BS.

At 1012, 1014, FIG. 10 illustrates communicating signaling that is related to sub-sequences. In FIG. 10, the signaling is transmitted by the BS to each UE 1001, 1003 and is received by each UE from the BS.

The UE 1001 is to transmit a multiplexed signal in the example shown, and generating signals and multiplexing those signals are shown at 1022, 1024. These operations are also shown in FIG. 8 and described at least above with reference to FIG. 8.

A sidelink transmission is shown at 1032, and transmitting a multiplexed signal by the UE 1001 to the UE 1003 may involve transmit processing (not shown). At a receive side, operations involve receiving the multiplexed signal by the UE 1003 from the UE 1001, and receive processing at 1042 may involve such operations as receive counterparts of transmit processing operations, and channel estimation or synchronization operations, for example.

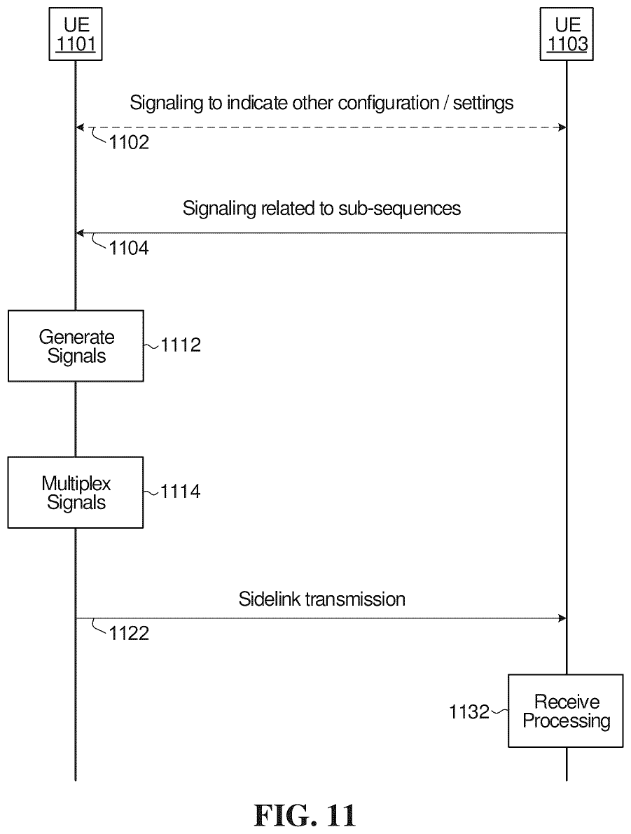

The sidelink communication embodiment in FIG. 10 involve communications between UEs that are controlled and configured by a BS. Embodiments that support direct communications between devices such as UEs need not necessarily involve a network device. NR sidelink, for example, supports a scenario in which UEs autonomously determine the resource that is used for SL data transmission with a sidelink control channel, and no BS is involved. FIG. 11 is a signal flow diagram for sidelink communications according to such an embodiment.

The signaling in FIG. 11 at 1102, 1104 is similar to the signaling shown at 802, 804 in FIG. 8, with the exception that the signaling in FIG. 11 is between two UEs 1101, 1103 instead of between a UE and a BS. The signaling related to sub-sequences, at 1104, may be or include sidelink control information (SCI) or PC5 (sidelink) radio resource control (RRC) signaling, for example.

Signal generation and multiplexing are shown at 1112, 1114, and are as disclosed elsewhere herein, such as with reference to FIG. 8. Sidelink transmission at 1122 involves the UE 1101 transmitting a multiplexed signal to the UE 1103, and the UE 1103 receiving the multiplexed signal from the UE 1101. Other transmit processing (not shown) may also be performed by the UE 1101, and receive processing by the UE 1103 at 1132 may involve receive processing that corresponds to such transmit processing. The receive processing at 1132 may also or instead involve such operations as channel estimation or synchronization operations.

The embodiment shown in FIG. 11 involves one UE (1103) transmitting signaling related to sub-sequences based upon which another UE (1101) is to generate signals at 1112 for multiplexing at 1114. In another embodiment, a transmitting UE that is to transmit a multiplexed signal also transmits, to another UE, signaling that is related to the sub-sequences. Referring to FIG. 11, such an embodiment involves transmitting the signaling at 1104 by the UE 1101 and receiving the signaling by the UE 1103.

FIGS. 8 to 11 are illustrative of various embodiments. More generally, a method consistent with the present disclosure may involve communicating signaling by a first communication device in a wireless communication network. The signaling is related to sub-sequences of a base sequence. Communicating signaling may involve transmitting the signaling or receiving the signaling, or, from a network-level perspective, both transmitting the signaling by one communication device and receiving the signaling by another communication device.

A multiplexed signal, which multiplexes a number of signals that are based on respective sub-sequences, is also communicated. For example, a method may involve transmitting a multiplexed signal in a wireless communication network, by the above-referenced first communication device to a second communication device. Another embodiment may involve receiving such a multiplexed signal from a communication device. Thus, communicating a multiplexed signal may involve transmitting, receiving, or both. For example, FIGS. 8 to 11 illustrate embodiments in which communicating signaling involves the following, any one or more of which may be provided or supported by different types of communication devices such as UEs or base stations:
receiving, by a UE, signaling from a BS or another UE, as shown byway of example at 802, 804, 902, 904, 1002, 1004, 1012, 1014, 1102, 1104;
receiving, by a BS, signaling from a UE, as shown byway of example at 802, 902, 1002, 1004;
transmitting, by a UE, signaling to a BS and/or to another UE, as shown by way of example at 802, 902, 1002, 1004, 1102, 1104;
transmitting, by a BS, signaling to one or more UEs, as shown by way of example at 802, 804, 902, 904, 1002, 1004, 1012, 1014.

These examples illustrate that communicating signaling may involve transmitting the signaling by any of various types of first communication device such as a UE or a base station or other network device, to any of various types of second communication device such as a UE or a base station or other network device. Communicating signaling may also or instead involve receiving the signaling at any of various types of first communication device such as a UE or a base station or other network device, from any of various types of second communication device such as a UE or a base station or other network device.

Similar to communicating signaling, communicating a multiplexed signal may involve transmitting and/or receiving, by any of various types of communication device such as a UE or a base station or other network device. Examples of communicating a multiplexed signal are shown in FIGS. 8 to 11 as an uplink transmission 822, a downlink transmission 922, or a sidelink transmission 1032, 1122.

A receiver or intended receiver (or receiving device) of a multiplexed signal may transmit or receive signaling before a multiplexed signal is received. In FIG. 8, for example, the BS is the intended receiver of a multiplexed signal and may transmit signaling at 802, 804 before receiving the multiplexed signal at 822. In FIG. 9, the UE is the intended receiver of a multiplexed signal and may receive signaling at 902, 904 before receiving the multiplexed signal at 922. In FIG. 10, the UE 1003 is the intended receiver of a multiplexed signal and may receive signaling at 1004, 1014 from the BS. In FIG. 11, the UE 1103 is the intended receiver of a multiplexed signal and may transmit signaling at 1104 to the UE 1101 before receiving a multiplexed signal at 1122.

Similarly, a transmitter or intended transmitter (or transmitting device) of a multiplexed signal may transmit or receive signaling before a multiplexed signal is transmitted. In FIG. 8, for example, the UE is the transmitter of the multiplexed signal and may receive signaling at 804 before transmitting the multiplexed signal at 822. The BS is the transmitter of a zero-padded transmission symbol in FIG. 9, but may transmit signaling at 902, 904 before transmitting the multiplexed signal at 922. In FIG. 10, the UE 1001 is the transmitter of a multiplexed signal and may receive signaling at 1002, 1012 before transmitting the multiplexed signal at 1032. In FIG. 11, the UE 1101 is the transmitter of a multiplexed signal and may receive signaling at 1102, 1104 from the UE 1103 before transmitting a multiplexed signal at 1122.

In some embodiments, signaling and a multiplexed signal are communicated between a transmitter and an intended receiver of the multiplexed signal, as in FIGS. 8, 9, and 11. Thus, in the context of communicating a multiplexed signal between a first communication device and a second communication device, in such embodiments communicating signaling may involve communicating the signaling between the first communication device and the second communication device. For example, communicating the signaling may involve transmitting the signaling by the first communication device to the second communication device, or receiving the signaling by the first communication device from the second communication device. Communicating the signaling may also or instead involve receiving the signaling by the first communication device from a third communication device, as shown byway of example in FIG. 10, in which signaling is communicated between the BS and each UE 1001, 1003, but a multiplexed signal is communicated between the UEs.

These are all illustrative of examples of communicating signaling and communicating a multiplexed signal.

The embodiments illustrated in FIGS. 8 to 11 are intended to be non-limiting examples. Other embodiments may include fewer, additional, and/or different features.

Consider a method that involves communicating, by a first communication device or a second communication in a wireless communication network, signaling related to sub-sequences of a base sequence. From a transmit-side perspective, such a method may involve transmitting, in the wireless communication network by the first communication device to the second communication device, a multiplexed signal that multiplexes a number of signals that are based on respective ones of the sub-sequences. From a receive-side perspective, such a method may involve receiving such a multiplexed signal by the second communication device from the first communication device.

The sub-sequences each include a unique subset of non-consecutive values from the base sequence. Those values are equally spaced apart by one or more zero values and are at different positions or locations within each of the sub-sequences. The signals similarly include signal components, in the time domain and in the frequency domain, that are also equally spaced apart from each other and are at different positions or locations within each of the signals. Consecutive components of the multiplexed signal include the components of different ones of the plurality of signals. This is one example of how a comb signal structure, which may be a double comb structure for two signals or more generally a multi-comb structure for two or more signals being multiplexed, may be described or characterized. Sequences and sub-sequences are referred to herein as having or including values or elements, and signals are referred to herein as having or including components or elements. Sequence or sub-sequence values and sequence or sub-sequence elements are intended to be equivalent terms. Similarly, signal components and signal elements are intended to be equivalent terms.

Another way to describe a comb structure for signals that are to be multiplexed is that, in a two-signal multiplexing embodiment for example, consecutive components of the multiplexed signal alternate back and forth, between components of the two signals that are multiplexed. More generally, with more than two signals, the consecutive components of the multiplexed signal sequentially cycle through a component of one signal, then a component of a different signal, and so on, signal-by-signal on a one-component per signal basis, until all components from all signals are multiplexed in the multiplexed signal.

A comb structure may also be described in terms of having the following properties, in both time domain and frequency domain: 1) signal components, which may also be referred to as elements, are equally distanced or spaced apart; 2) each signal, for one port or beam in some embodiments, occupies a different set of positions or locations; and 3) there are no “zero” positions or locations, that do not carry a component from one of the signals, in the multiplexed signal.

Alignment may be another way to express the concept of a comb structure. Each signal may be considered as including spaced apart components at different locations such that each component aligns with a zero or null position or location of each other signal. Put another way, signal components are distanced or spaced apart and uniquely aligned in each signal, such that at each position or location in time domain and frequency domain only one signal has a non-zero component or element.

Further examples are also provided above. As previously described, comb structure is intended to convey the notion of non-zero values being non-consecutive or non-contiguous, in time domain or frequency domain. Stated another way, in a sequence or signal that has a comb structure, any two adjacent non-zero values or elements are separated by one or more zero values or elements. Signals that are to be multiplexed have what may be referred to as complementary comb structures, in that positions or locations in one signal that have been set to zero have not been set to zero in at least one other signal. Non-zero values or elements in each sequence or signal are separated by multiple values or elements that have been set to zero, and at any index or position in time or frequency only one of the sequences or signals has a value or element that has not been set to zero.

Sub-sequences, like signals, also have a comb structure. A comb structure may be described in the same way for signals (based on signal components or elements) and sub-sequences (based on sub-sequence values or elements). Any of the descriptions herein for comb signal structure may be extended to sub-sequences.

Regarding a base sequence and a multiplexed signal, generating or forming sub-sequences from a base sequence may be considered to be somewhat of an inverse to multiplexing signals into a multiplexed signal. In generating or forming sub-sequences from a base sequence, values or elements of the base sequence are in effect uniquely distributed or interspersed among the sub-sequences, such that each value or element in the base sequence is part of only one sub-sequence and consecutive values or elements in the base sequence are distributed among multiple sub-sequences. In this way, each sub-sequence includes a subset of non-consecutive values from the base sequence, and the subset for each sub-sequence is unique in that for each sub-sequence, no other sub-sequence includes any of the same base sequence values. In an opposite or inverse sense, in multiplexing signals together into a multiplexed signal, signal components are in effect collected together from different signals to form the multiplexed signal.

In the context of a transmit-side method or a receive-side method, any of various features disclosed herein may be provided. For example, any one or more of the following may be provided, in any of various combinations:
the base sequence may be or include a binary sequence;
the base sequence may be or include a Gold sequence or a ZC sequence;
the respective sub-sequences, upon which the signals that are multiplexed by the multiplexed signal are based, may be unique subsets of non-consecutive π/2-BPSK modulated values from the base sequence;
the base sequence may be of length L=N/M, where N is a number of frequency subcarriers and M is a number of the respective sub-sequences;
the modulated values of the base sequence may be or include a modulated sequence [symbol] =[s₀ s₁ . . . s_{L-1}];
the respective sub-sequences may include M respective sub-sequences: [symbol] =[0 . . . sₘ 0 . . . s_{m+M} 0 . . . s_{m+(K-1)M} 0 . . . ] form=0, 1, . . . , M−2 is an index and K=L/M, [symbol] =[sₘ 0 . . . s_{m+M} 0 . . . s_{m+(K-1)M} 0 . . . ] for m=0, and [symbol] =[0 . . . sₘ 0 . . . s_{m+M} 0 . . . s_{m+(K-1)M}] for m=M−1;
the signals based on the sub-sequences may include M signals

$${\vec{s}}^{( m )} = [ {\vec{s}}_{L}^{( m )} {e}^{j 2 π m / M} {\vec{s}}_{L}^{( m )} … {e}^{j 2 π ( M - 1 ) m / M} {\vec{s}}_{L}^{( m )} ] ;$$

the signals based on the sub-sequences may be or include DMRSs associated with the first communication device;
the signals based on the sub-sequences may be or include SRSs associated with the first communication device;
the signals based on the sub-sequences may be or include synchronization signals associated with different respective antenna beams for a simultaneous multi-beam synchronization channel;
communicating the signaling may involve transmitting the signaling by the first communication device to the second communication device;
communicating the signaling may involve receiving the signaling by the first communication device from the second communication device;
communicating the signaling may involve receiving the signaling by the first communication device from a third communication device;
communicating the signaling may involve receiving the signaling by the second communication device from the first communication device;
communicating the signaling may involve transmitting the signaling by the second communication device to the first communication device;
communicating the signaling may involve receiving the signaling by the second communication device from a third communication device.

These method examples are illustrative and non-limiting embodiments, and other embodiments may include additional or different features disclosed herein.

Embodiments are not in any way limited to methods.

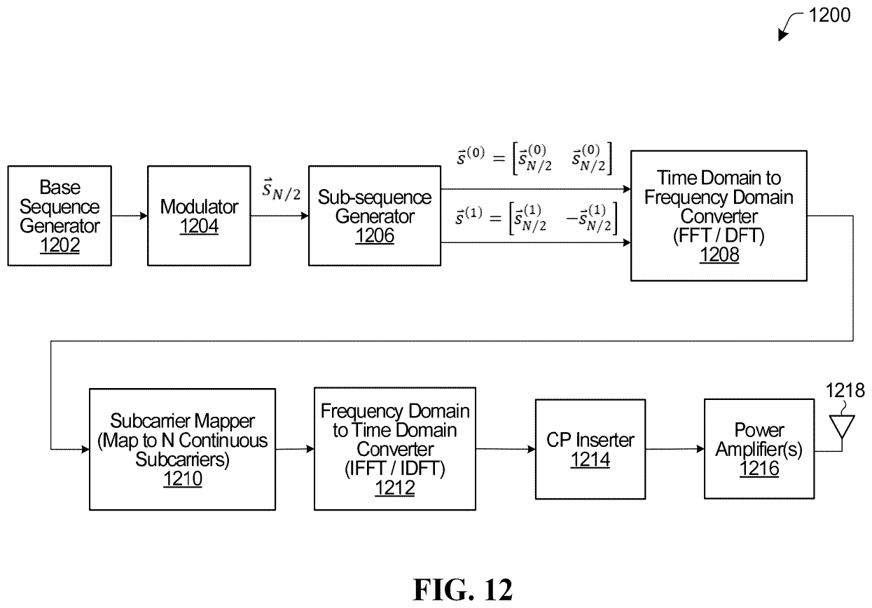

FIG. 12 is a block diagram illustrating an example transmitter 1200 according to an embodiment. It is to be understood that components in FIG. 12 may implement a transmit function of a wireless device or a network device such as a base station. The example transmitter 1200 includes a base sequence generator 1202, a modulator 1204, a sub-sequence generator 1206, a time domain to frequency domain converter 1208, a subcarrier mapper 1210, a frequency domain to time domain converter 1212, a cyclic prefix (CP) inserter 1214, one or more power amplifiers 1216, and one or more antennas or antenna elements 1218, interconnected as shown. Other embodiments may include additional, fewer, or different elements interconnected in a similar or different way. It also to be understood that the components in the example transmitter 1200 are specific, for the sole purpose of illustration of one possible embodiment. The present disclosure is not limited to transmitters that are consistent with the specific example transmitter 1200.

The elements shown in FIG. 12 may be implemented in any of various ways, such as in hardware, firmware, or one or more components that execute software. The present disclosure is not limited to any specific type of implementation, and implementation details may vary between different devices, for example.

Operation of the example transmitter 1200 will now be described by way of example. The base sequence generator 1202 is configured, by executing software for example, to generate or otherwise obtain a base sequence in any of various ways as disclosed elsewhere herein. The modulator 1204 is illustrative of an embodiment in which a base sequence is modulated, and is configured, by executing software for example, to modulate the base sequence and thereby generate a modulated base sequence. The sub-sequence generator 1206 is configured, by executing software for example, to generate sub-sequences based on the base sequence. The modulated base sequence at the input of the sub-sequence generator 1206 and the sub-sequences at the output of the sub-sequence generator are illustrative of one embodiment in which two sub-sequences are generated from a modulated base sequence, consistent with an example provided above.

The time domain to frequency domain converter 1208 is configured, by executing software for example, to convert the sub-sequences from time domain to frequency domain, by performing a fast Fourier transform (FFT) or discrete Fourier transform (DFT), for example.

The subcarrier mapping component 1210 is configured, by executing software for example, to map the sub-sequences, after conversion to frequency domain, to continuous frequency subcarriers. The sub-sequences have complementary comb structures as described elsewhere herein, and mapping the frequency domain sub-sequences to consecutive subcarriers also in effect implements multiplexing. The frequency domain to time domain converter 1212 is configured, by executing software for example, to transform the resultant frequency domain multiplexed signal from the frequency domain to the time domain, by performing an inverse FFI (IFFT) or inverse DFT (IDFT), for example. Some embodiments may use CPs, and the CP inserter 1214 is illustrative of such embodiments. The CP inserter 1214 is configured, by executing software for example, to handle CP insertion.

The power amplifier(s) component 1216 is illustrative of transmit chain components that may be provided to transmit a multiplexed signal. For example, there may be one PA/transmit chain per antenna or antenna element 1218, or multiple antennas or antenna elements may be coupled to one PA/transmit chain.

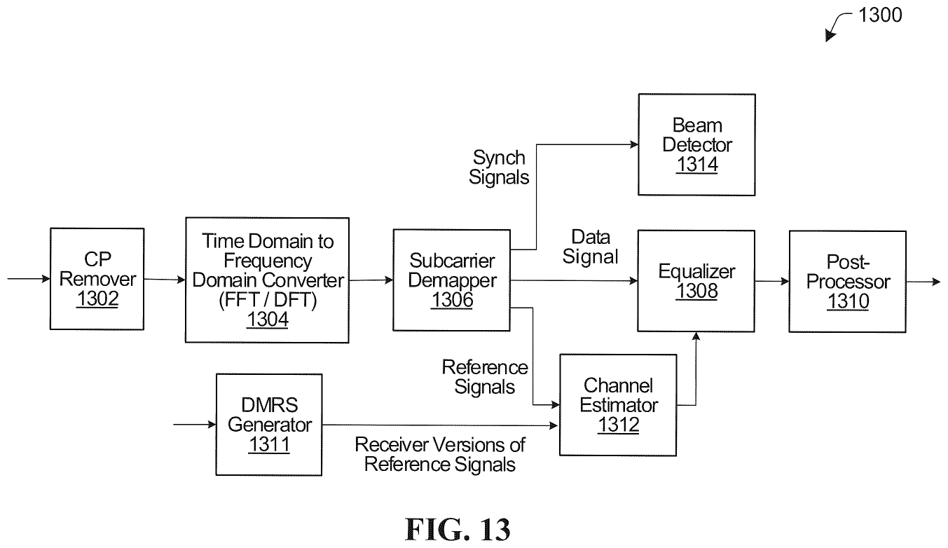

FIG. 13 is a block diagram illustrating an example receiver according to an embodiment. The example receiver 1300 includes a CP remover 1302, a time domain to frequency domain converter 1304, a subcarrier demapper 1306, a beam detector 1214, an equalizer 1408, a post-processor 1210, a DMRS generator 1311, and a channel estimator 1312, interconnected as shown. Other embodiments may include additional, fewer, or different elements interconnected in a similar or different way.

The elements shown in FIG. 13 may be implemented in any of various ways, such as in hardware, firmware, or one or more components that execute software. As noted elsewhere herein, the present disclosure is not limited to any specific type of implementation, and implementation details may vary between different devices, for example.

Receiver operations may include CP removal, conversion to frequency domain by an FFI or a DFT for example, and subcarrier demapping and demultiplexing. Subcarrier demapping may demultiplex multiplexed synch signals, multiplexed reference signals such as DMRSs or SRSs, or possibly also or instead a data signal. In a beam sweeping embodiment, demultiplexed synch signals are used for beam detection by the beam detector 1314. A receiver may also or instead support or perform channel estimation by the channel estimator 1312 based on multiple received reference signals and locally generated receiver versions of the reference signals. A data signal, which may be received with or separately from one or more synch signals and/or one or more reference signals, may be processed or equalization and/or any of various other types of post-processing, such as further processing based on transmitter precoding for example.

In the example receiver 1300, the CP remover 1302 is configured, by executing software for example, to remove a cyclic prefix; the time domain to frequency domain converter 1304 is configured, by executing software for example, to convert a received time domain signal to frequency domain by performing an FFT or a DFT, for example; and the subcarrier demapper 1306 is configured, by executing software for example, to perform subcarrier demapping. In an embodiment that supports multiplexed synch signals, the beam detector 1314 is configured, by executing software for example, to perform beam detection based on multiple narrow beams and associated synch signals rather than a single wider beam. The equalizer 1308 is configured, by executing software for example, to equalize a received data signal output from the subcarrier demapper 1306. The channel estimator 1312 is configured, by executing software for example, to process received reference signals output from the subcarrier demapper 1306 and to produce channel estimates that are provided to the equalizer 1308; and the post-processor 1310 is configured, by executing software for example, to process the output of the equalizer. The channel estimator 1312 receives a receiver version of the reference signal from the DMRS generator 1311 for channel estimation in the example receiver 1300. More generally, the channel estimator 1312 may be configured, by executing software for example, to generate or otherwise obtain receiver versions of reference signals and use them to perform channel estimation. The post-processor 1310 may take into account any transmit processing performed at a transmitter, for example.

FIG. 13 is intended to illustrate features that may be provided or supported at a receiver, but a receiver need not provide or support all of the illustrated features. For example, a receiver may support multiplexed synch signals but not multiplexed reference signals, or may support multiplexed reference signals but not support multiplexed synch signals. It should also be appreciated that not all of the signals illustrated in FIG. 13 are necessarily received at the same time. Synch signals, data signals, and reference signals may be received and processed at different times.

Like FIG. 12, FIG. 13 is an illustrative and non-limiting example.

The present disclosure encompasses various embodiments, including not only method embodiments, but also other embodiments such as apparatus embodiments and embodiments related to non-transitory computer readable storage media. Embodiments may incorporate, individually or in combinations, the features disclosed herein.

An apparatus may include a processor and a non-transitory computer readable storage medium, coupled to the processor, storing programming for execution by the processor. In FIG. 3, for example, the processors 210, 260, 276 may each be or include one or more processors, and each memory 208, 258, 278 is an example of a non-transitory computer readable storage medium, in an ED 110 and a TRP 170, 172. A non-transitory computer readable storage medium need not necessarily be provided only in combination with a processor, and may be provided separately in a computer program product, for example.

As an illustrative example, programming stored in or on a non-transitory computer readable storage medium may include instructions to, or to cause a processor to, communicate signaling by a first communication device and/or a second communication device in a wireless communication network. The signaling is related to sub-sequences of a base sequence. The programming may include instructions to, or to cause the processor to, transmit by the first communication device to the second communication device (or receive by the second communication device from the first communication device) a multiplexed signal that multiplexes signals that are based on respective ones of the sub-sequences. As in other embodiments, the sub-sequences each include a unique subset of non-consecutive values from the base sequence, and those values from the base sequence are equally spaced apart by one or more zero values and at different positions within each of the sub-sequences. The signals include components that are equally spaced apart and at different positions within each of the signals such that consecutive components of the multiplexed signal include the components of different ones of the plurality of signals.

Embodiments related to apparatus or non-transitory computer readable storage media may include any one or more of the following features, for example, which are also discussed elsewhere herein:
the base sequence may be or include a binary sequence;
the base sequence may be or include a Gold sequence or a ZC sequence;
the respective sub-sequences, upon which the signals that are multiplexed by the multiplexed signal are based, may be unique subsets of non-consecutive π/2-BPSK modulated values from the base sequence;
the base sequence may be of length L=N/M, where N is a number of frequency subcarriers and M is a number of the respective sub-sequences;
the modulated values of the base sequence may be or include a modulated sequence [symbol] =[s₀ s₁ . . . s_{SL-1}];
the respective sub-sequences may include M respective sub-sequences: [symbol] =[0 . . . sₘ 0 . . . s_{m+M} 0 . . . s_{m+(K-1)M} 0 . . . ] For m=0, 1, . . . , M−2 is an index and K=L/M, [symbol] )=[sₘ 0 . . . s_{m+M} 0 . . . s_{m+(K-1)M} 0 . . . ] for m=0, and [symbol] =[0 . . . sₘ 0 . . . s_{m+M} 0 . . . s_{m+(K-1)M}] for m=M−1
the signals based on the sub-sequences may include M signals

$${\vec{s}}^{( m )} = [ {\vec{s}}_{L}^{( m )} {e}^{j 2 π m / M} {\vec{s}}_{L}^{( m )} … {e}^{j 2 π ( M - 1 ) m / M} {\vec{s}}_{L}^{( m )} ] ;$$

the signals based on the sub-sequences may be or include DMRSs associated with the first communication device;
the signals based on the sub-sequences may be or include SRSs associated with the first communication device;
the signals based on the sub-sequences may be or include synchronization signals associated with different respective antenna beams for a simultaneous multi-beam synchronization channel;
the programming includes instructions to, or to cause a processor to, communicate the signaling by transmitting the signaling by the first communication device to the second communication device;
the programming includes instructions to, or to cause a processor to, communicate the signaling by receiving the signaling by the first communication device from the second communication device;
the programming includes instructions to, or to cause a processor to, communicate the signaling by receiving the signaling by the first communication device from a third communication device;
the programming includes instructions to, or to cause a processor to, communicate the signaling by receiving the signaling by the second communication device from the first communication device;
the programming includes instructions to, or to cause a processor to, communicate the signaling by transmitting the signaling by the second communication device to the first communication device;
the programming includes instructions to, or to cause a processor to, communicate the signaling by receiving the signaling by the second communication device from a third communication device.

Embodiments disclosed herein encompass communication of comb structure based multiplexed signals, such as DMRSs, SRSs, or synch signals for simultaneous multi-beam synch channels, in the time domain, so that the multiplexed signals can have low PAPR. Selection of a base sequence to use for multiplexed signals is secondary, although certain types of sequences such as Gold sequences and ZC sequences may be preferred.

With comb structure based signals in both frequency and time domain, each signal, and accordingly in some embodiments each antenna port or beam, is associated with a unique set of subcarriers in the frequency domain and pulses in the time domain. A benefit of introducing a comb structure in the time domain is low PAPR. Pulses of each signal, for a respective port or beam for example, occupy a different comb set, and therefore the combined time domain sequence has a PAPR similar to that of SC-OQAM in some embodiments. Stated another way, each reference signal or beam may use a unique comb set in the time domain, which makes a multiplexed multi-port or multi-beam signal a single-carrier signal that has a low PAPR. Combined with π/2 rotation in some embodiments, the PAPR of a multiplexed signal can be further reduced.

A comb structure in frequency domain, with different respective sets of frequency domain subcarriers for multiplexed signals, can provide orthogonality among signals in some embodiments. A double comb structure is provided in some embodiments, in both the frequency and the time domain, and thus reference signal or beams signal components may be orthogonal to each other, which allows interference-free or at least reduced-interference channel estimation or beam detection.

Thus, a time domain comb structure may be used to provide low PAPR of signals that are multiplexed, and a frequency domain comb structure may be used to provide orthogonality among signals that are multiplexed.

Low PAPR may be advantageous for any of various types of multiplexed signals, including but not limited to DMRSs and synch signals. For simultaneous multi-beam synch channels, multiplexing for different beams may be advantageous in terms of any of: reducing overhead, reducing beam scanning time, and refining or increasing beam spatial resolution relative to beam scanning using wider beams.

Although this disclosure has been described with reference to illustrative embodiments, this description is not intended to be construed in a limiting sense. Various modifications and combinations of the illustrative embodiments, as well as other embodiments of the disclosure, will be apparent to persons skilled in the art upon reference to the description. It is therefore intended that the appended claims encompass any such modifications or embodiments.

Features disclosed herein in the context of method embodiments, for example, may also or instead be implemented in apparatus or computer program product embodiments. In addition, although embodiments are described primarily in the context of methods and apparatus, other implementations are also contemplated, as instructions stored on one or more non-transitory computer-readable media, for example. Such media could store programming or instructions to perform any of various methods consistent with the present disclosure.

Disclosed embodiments are also not intended to be limited to any particular applications. For example, the proposed solutions can be used in integrated sensing and communication (ISAC) as well. In ISAC, reflected paths need to fall in the CP region, so that they do not cause ISI to each other. When CP length is not long enough to accommodate the reflected paths, zero padding can be used to create addition guard room. This type of application may be appropriate, for example, for use of DFT-s-OFDM/SC-OQAM in ISAC.

Although aspects of the present invention have been described with reference to specific features and embodiments thereof, various modifications and combinations can be made thereto without departing from the invention. The description and drawings are, accordingly, to be regarded simply as an illustration of some embodiments of the invention as defined by the appended claims, and are contemplated to cover any and all modifications, variations, combinations or equivalents that fall within the scope of the present invention. Therefore, although embodiments and potential advantages have been described in detail, various changes, substitutions and alterations can be made herein without departing from the invention as defined by the appended claims. Moreover, the scope of the present application is not intended to be limited to the particular embodiments of the process, machine, manufacture, composition of matter, means, methods and steps described in the specification. As one of ordinary skill in the art will readily appreciate from the disclosure of the present invention, processes, machines, manufacture, compositions of matter, means, methods, or steps, presently existing or later to be developed, that perform substantially the same function or achieve substantially the same result as the corresponding embodiments described herein may be utilized according to the present invention. Accordingly, the appended claims are intended to include within their scope such processes, machines, manufacture, compositions of matter, means, methods, or steps.

Moreover, any module, component, or device exemplified herein that executes instructions may include or otherwise have access to a non-transitory computer readable or processor readable storage medium or media for storage of information, such as computer readable or processor readable instructions, data structures, program modules, and/or other data. A non-exhaustive list of examples of non-transitory computer readable or processor readable storage media includes magnetic cassettes, magnetic tape, magnetic disk storage or other magnetic storage devices, optical disks such as compact disc read-only memory (CD-ROM), digital video discs or digital versatile disc (DVDs), Blu-ray Disc™, or other optical storage, volatile and non-volatile, removable and nonremovable media implemented in any method or technology, random-access memory (RAM), read-only memory (ROM), electrically erasable programmable read-only memory (EEPROM), flash memory or other memory technology. Any such non-transitory computer readable or processor readable storage media may be part of a device or accessible or connectable thereto. Any application or module herein described may be implemented using instructions that are readable and executable by a computer or processor may be stored or otherwise held by such non-transitory computer readable or processor readable storage media.

What is claimed is:

1. A method comprising:
communicating, by a first communication device in a wireless communication network, signaling related to sub-sequences of a base sequence; and
transmitting, in the wireless communication network by the first communication device to a second communication device, a multiplexed signal comprising a plurality of signals, each signal of the plurality of signals being based on respective sub-sequences of the sub-sequences,
the sub-sequences each comprising a respective unique subset of non-consecutive values from the base sequence, equally spaced apart by one or more zero values and at different positions within each sub-sequence of the sub-sequences, and
the plurality of signals comprising components that are equally spaced apart and at different positions within each signal of the signals such that consecutive components of the multiplexed signal comprise components of different signals of the plurality of signals.

2. The method of claim 1, wherein the base sequence comprises at least one of a binary sequence, a Gold sequence, or a Zadoff-Chu (ZC) sequence.

3. The method of claim 1, wherein the respective sub-sequences comprise unique subsets of non-consecutive π/2-binary phase shift keying (BPSK) modulated values from the base sequence.

4. The method of claim 3, wherein:
the base sequence is of a length L=N/M, wherein N is a number of frequency subcarriers, and M is a number of the respective sub-sequences;
the non-consecutive π/2-BPSK modulated values from the base sequence comprise a modulated sequence [symbol] =[s₀ s₁ . . . s_{L-1}];
the respective sub-sequences comprise M respective sub-sequences: [symbol]
=[0 . . . sₘ 0 . . . s_{m+M} s_{m+(K-1)M} 0] for m=0, 1, . . . , M−2 is an index, and
$$K = \frac{L}{M} ,$$ [symbol]
=[sₘ 0 . . . s_{m+M} 0 . . . s_{m+(K-1)M} 0 . . . ] for m=0, and [symbol]
=[0 . . . sₘ 0 . . . s_{m+M} 0 . . . s_{m+(K-1)M}] for m=M−1; and
the plurality of signals comprises M signals
$${\vec{s}}^{( m )} = [ {\vec{s}}_{L}^{( m )} {e}^{j 2 π m / M} {\vec{s}}_{L}^{( m )} … {e}^{j 2 π ( M - 1 ) m / M} {\vec{s}}_{L}^{( m )} ] .$$

5. The method of claim 1, wherein the plurality of signals comprise at least one of: demodulation reference signals (DMRSs) associated with the first communication device, sounding reference signals (SRSs) associated with the first communication device, or synchronization signals associated with different respective antenna beams.

6. A method comprising:
communicating, by a second communication device in a wireless communication network, signaling related to sub-sequences of a base sequence; and
receiving, in the wireless communication network by the second communication device from a first communication device, a multiplexed signal comprising a plurality of signals, each signal of the plurality of signals being based on respective sub-sequences of the sub-sequences,
the sub-sequences each comprising a respective unique subset of non-consecutive values from the base sequence, equally spaced apart by one or more zero values and at different positions within each sub-sequence of the sub-sequences, and
the plurality of signals comprising components that are equally spaced apart and at different positions within each signal of the signals such that consecutive components of the multiplexed signal comprise components of different signals of the plurality of signals.

7. The method of claim 6, wherein the base sequence comprises at least one of a binary sequence, a Gold sequence, or a Zadoff-Chu (ZC) sequence.

8. The method of claim 6, wherein the respective sub-sequences comprise unique subsets of non-consecutive π/2-binary phase shift keying (BPSK) modulated values from the base sequence.

9. The method of claim 8, wherein:
the base sequence is of a length L=N/M, wherein N is a number of frequency subcarriers, and M is a number of the respective sub-sequences;
the non-consecutive π/2-BPSK modulated values from the base sequence comprise a modulated sequence, [symbol] =[s₀ s₁ . . . s_{L-1}];
the respective sub-sequences comprise M respective sub-sequences: [symbol]
=[0 sₘ 0 . . . s_{m+M} 0 . . . s_{m+(K-1)M} 0 . . . ] for m=0, 1, . . . , M−2 is an index, and
$$K = \frac{L}{M} ,$$ [symbol]
=[sₘ 0 . . . s_{m+M} 0 . . . s_{m+(K-1)M} 0 . . . ] for m=0, and [symbol]
=[0 . . . sₘ 0 . . . s_{m+M} 0 . . . s_{m+(K-1)M}] for m=M−1; and
the plurality of signals comprises M signals
$${\vec{s}}^{( m )} = [ {\vec{s}}_{L}^{( m )} {e}^{j 2 π m / M} {\vec{s}}_{L}^{( m )} … {e}^{j 2 π ( M - 1 ) m / M} {\vec{s}}_{L}^{( m )} ] .$$

10. The method of claim 6, wherein the plurality of signals comprise at least one of: demodulation reference signals (DMRSs) associated with the first communication device, sounding reference signals (SRSs) associated with the first communication device, or synchronization signals associated with different respective antenna beams.

11. An apparatus comprising:
at least one processor; and
a non-transitory computer readable storage medium, coupled to the at least one processor, storing programming for execution by the at least one processor, the programming including instructions to cause the apparatus to perform:
communicating, in a wireless communication network, signaling related to sub-sequences of a base sequence; and
transmitting, to a second communication device in the wireless communication network, a multiplexed signal comprising a plurality of signals, each signal of the plurality of signals being based on respective sub-sequences of the sub-sequences,
the sub-sequences each comprising a respective unique subset of non-consecutive values from the base sequence, equally spaced apart by one or more zero values and at different positions within each sub-sequence of the sub-sequences, and
the plurality of signals comprising components that are equally spaced apart and at different positions within each signal of the signals such that consecutive components of the multiplexed signal comprise components of different signals of the plurality of signals.

12. The apparatus of claim 11, wherein the base sequence comprises at least one of a binary sequence, a Gold sequence, or a Zadoff-Chu (ZC) sequence.

13. The apparatus of claim 11, wherein the respective sub-sequences comprise unique subsets of non-consecutive π/2-binary phase shift keying (BPSK) modulated values from the base sequence.

14. The apparatus of claim 13, wherein:
the base sequence is of a length L=N/M, wherein N is a number of frequency subcarriers, and M is a number of the respective sub-sequences;
the non-consecutive π/2-BPSK modulated values from the base sequence comprise a modulated sequence [symbol] =[s₀ s₁ . . . s_{L-1}];
the respective sub-sequences comprise M respective sub-sequences: [symbol]
=[0 . . . sₘ 0 . . . s_{m+M} 0 . . . s_{m+(K-1)M} 0 . . . ] for m=0, 1, . . . , M−2 is an index, and
$$K = \frac{L}{M} ,$$ [symbol]
=[sₘ 0 . . . s_{m+M} 0 . . . s_{m+(K-1)M} 0 . . . ] for m=0, and [symbol]
=[0 . . . sₘ 0 . . . s_{m+M} 0 . . . s_{m+(K-1)M}] for m=M−1; and
the plurality of signals comprises M signals
$${\vec{s}}^{( m )} = [ {\vec{s}}_{L}^{( m )} {e}^{j 2 π m / M} {\vec{s}}_{L}^{( m )} … {e}^{j 2 π ( M - 1 ) m / M} {\vec{s}}_{L}^{( m )} ] .$$

15. The apparatus of claim 11, wherein the plurality of signals comprise at least one of: demodulation reference signals (DMRSs) associated with the apparatus, sounding reference signals (SRSs) associated with the apparatus, or synchronization signals associated with different respective antenna beams.

16. An apparatus comprising:
at least one processor; and
a non-transitory computer readable storage medium, coupled to the at least one processor, storing programming for execution by the at least one processor, the programming including instructions to cause the apparatus to perform:
communicating, in a wireless communication network, signaling related to sub-sequences of a base sequence; and
receiving, from a first communication device in the wireless communication network, a multiplexed signal comprising a plurality of signals, each signal of the plurality of signals being based on respective sub-sequences of the sub-sequences,
the sub-sequences each comprising a respective unique subset of non-consecutive values from the base sequence, equally spaced apart by one or more zero values and at different positions within each sub-sequence of the sub-sequences, and
the plurality of signals comprising components that are equally spaced apart and at different positions within each signal of the signals such that consecutive components of the multiplexed signal comprise components of different signals of the plurality of signals.

17. The apparatus of claim 16, wherein the base sequence comprises at least one of a binary sequence, a Gold sequence, or a Zadoff-Chu (ZC) sequence.

18. The apparatus of claim 16, wherein the respective sub-sequences comprise unique subsets of non-consecutive π/2-binary phase shift keying (BPSK) modulated values from the base sequence.

19. The apparatus of claim 18, wherein:
the base sequence is of a length L=N/M, wherein N is a number of frequency subcarriers, and M is a number of the respective sub-sequences;
the non-consecutive π/2-BPSK modulated values from the base sequence comprise a modulated sequence [symbol] =[s₀ s₁ s_{L-1}];
the respective sub-sequences comprise M respective sub-sequences: [symbol]
=[0 . . . sₘ 0 . . . s_{m+M} 0 . . . s_{m+(K-1)M} 0 . . . ] for m=0, 1, . . . , M−2 is an index, and
$$K = \frac{L}{M} ,$$ [symbol]
=[sₘ 0 . . . s_{m+M} 0 . . . s_{m+(K-1)M} 0 . . . ] for m=0, and [symbol]
=[0 sₘ 0 . . . s_{m+M} . . . 0 . . . s_{m+(K-1)M}] for m=M−1; and
the plurality of signals comprises M signals
$${\vec{s}}^{( m )} = [ {\vec{s}}_{L}^{( m )} {e}^{j 2 π m / M} {\vec{s}}_{L}^{( m )} … {e}^{j 2 π ( M - 1 ) m / M} {\vec{s}}_{L}^{( m )} ] .$$

20. The apparatus of claim 16, wherein the plurality of signals comprise at least one of: demodulation reference signals (DMRSs) associated with the first communication device, sounding reference signals (SRSs) associated with the first communication device, or synchronization signals associated with different respective antenna beams.
